(19) United States
(12) Patent Application Publication
(10) Pub. No.: US 2014/0103810 A1
(43) Pub. Date: Apr. 17, 2014

(54) LED ENGINE AND CONTROL SYSTEM

(71) Applicant: MONDAY TECHNOLOGIES LLC, Wixom, MI (US)

(72) Inventors: James B. Shaffer, II, Wixom, MI (US); Michael Mulholland, Commerce Township, MI (US); Christopher E. Andrews, South Lyon, MI (US); Michael J. Kujawski, Ann Arbor, MI (US); Ernest Pacsai, Wixom, MI (US); Edmund A. Simon, Howell, MI (US); Tim Green, Holly, MI (US)

(73) Assignee: MONDAY TECHNOLOGIES LLC, Wixom, MI (US)

(21) Appl. No.: 13/840,190

(22) Filed: Mar. 15, 2013

Related U.S. Application Data
(60) Provisional application No. 61/677,394, filed on Jul. 30, 2012.

(51) Int. Cl. H05B 33/08; H05B 37/02

(52) U.S. Cl. CPC H05B 33/0893; H05B 37/0272
USPC 315/114; 315/316

(57) ABSTRACT

A lighting system having a controller, a plurality of lights, and a bidirectional bus interconnecting the controller with the lights. The controller controls of the status of the various lights including the on/off state and intensity of the light by transmitting not only commands along the bidirectional bus, but also the address of the individual lights along the bus to the lights. This address is decoded by a circuit associated with each light to permit the lights to be individually controlled if desired.

### CROSS-REFERENCE TO RELATED APPLICATIONS

This application claims priority of U.S. Provisional Application 61/677,394 filed Jul. 30, 2012, the contents of which are incorporated herein by reference.

### FIELD OF THE INVENTION

The invention relates to a lighting system and more specifically, a networked LED lighting system.

### BACKGROUND OF THE INVENTION

Control systems for light engines featuring light emitting diodes (LED) are generally known in the art. These control systems allow users to operate the individual light engines based on specific grouping and light performance characteristic outputs. However, current systems are limited in their control of the lighting engine groups and often require a rewiring of the light engines and control systems to enable the lighting groups to be reassigned.

In traditional lighting networks instructions are sent from the controller to the individual lights which are used to adjust the properties of the light, such as the brightness, hue, or color. However, these systems do not provide for return communication from the lights back to the controller. If there is return communication between the LEDs and the controller, it is often limited to the status of the LED or other basic function. As such, lighting networks are limited to the simple network operations that can be achieved using one-way communication between the controller and the LEDs. As general networking techniques have become more advanced, two-way communications between controllers and targets have improved overall network performance by allowing targets to confirm instructions from the controller and for the controller to use target feedback to better manage the network.

Additionally, LEDs have different characteristics than traditional lighting units, such as incandescent bulbs, and that LEDs typically operate at much lower temperatures. This can create problems where a lighting system is used in an outdoor environment where the light and its housing may become covered with snow, ice, and the like. Additionally, a lack of temperature control for the light engine can create problems when used in an indoor setting, wherein the housing may become too hot to touch and not conform to local standards or codes.

As the size and capability of lighting networks has expanded, it has become increasingly important for the controller to properly manage the lighting network. This network management can include adding or removing LEDs to the network, grouping or reassigning LEDs within the network, or identifying specific LED targets to the user. Many consumers have come to expect devices to automatically network or come on line without having to individually set up every component of the network.

Accordingly, it is desired to have a new light engine and lighting control system which can regroup the individual light engines allowing for increased user control without the need for rewiring. Furthermore, the system should allow for two-way communication between the light engines and the controller to maximize the functionality of the network by enabling the controller to use sophisticated network communications. The system should also be able to control the thermal characteristics of the light engine, the LEDs, and the housing to maximize the lifetime of the LEDs and improve the overall usability of the lighting system. These systems should also be simple to configure and allow for a wide range of user customization.

### SUMMARY OF THE INVENTION

The light engine control system of the present invention includes at least one controller and possibly a plurality of controllers, a remote user device, a lighting network bus, and a plurality of lighting units. The one or more controllers generate commands based on user input and the response received from the lighting units. The commands are transmitted to the lighting units over the lighting network bus and are operable to change the state of the lighting units. The remote user device is wirelessly connected to the controller and transmits user inputs to the controller and receives controller responses. The lighting units are connected to the lighting network bus and have at least one solid state light (SSL), e.g. an LED, and a plurality of operating states. The lighting units and the controller are in two-way communication with one another over the lighting network bus.

The one or more controllers are also able to automatically monitor and manage the lighting network. The one or more controllers are operable to automatically add and remove SSLs from the lighting network, assign or be assigned addresses to the SSLs, and change the grouping of the SSLs. The one or more controllers can also perform these tasks in response to input from the remote user device to give the user full control over the lighting network.

In addition to the automatic controller commissioning of the lighting network, one or more user operated external magnetic controllers may be used to initialize a large group of SSLs. The magnetic controller erases the old addresses of the SSLs which induces the controller to assign new addresses to the SSLs. The magnetic controller is not powered and may also be used to manually adjust the settings of the SSLs without using the controller to send commands over the lighting network bus.

The system is also able to operate with multiple controllers communicating over the lighting network bus. All of the controllers on the lighting network bus check for available bus time and work together to sort out controller priority. The lighting units will respond to commands from any controller and responses from the lighting units will be sent to every controller connected to the lighting network bus.

In addition to the increased control of the lighting units grouping and light characteristics, the control system and the lighting units of the present invention include thermal sensors and heating elements in thermal communication with a housing of the lighting units. This enables the lighting units to determine the temperature of the housing, and if necessary, supply power to the heating element thereby raising the temperature of the housing to melt snow or ice that may accumulate on the housing. In addition, the lighting unit of the present invention can determine the temperature of the housing and if necessary reduce power to the SSLs to reduce the temperature of the housing.

Another feature of the present invention is the ability to change the lighting characteristics of the light engine without a primary or secondary controller. This is accomplished with a magnetic tool which produces a strong magnetic field that is held for a set duration of time near the light engine whose lighting characteristics are to be changed. For example, holding the magnet tool near the light engine for a short duration, such as a second, might increase the brightness of the LED; or holding the magnet near the light engine for a long duration, such as five seconds, might change the color or hue of the light engine. It is appreciated that various combinations of timing and output characteristics can be achieved using this system and method.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a block diagrammatic view illustrating a preferred embodiment of the present invention;

FIG. 2 is a flowchart illustrating the general operation of the lighting system of the present invention;

FIG. 3 is a flowchart illustrating the control of the lights as a function of the temperature of the lights;

FIG. 4 illustrates a flowchart of the reconfiguration of the address of the lights;

FIG. 5 is an elevational side view of a building having a light engine control system and light engines of the present invention;

FIG. 6 is a schematic of a light engine control system of the present invention graph showing the control signals of a lighting control system;

FIG. 7 is an alternate light engine control system of the present invention;

FIG. 8 is a prospective view of a light engine and housing;

FIG. 9 is a top view of a circuit board of the light engine of the present invention;

FIG. 10 is a schematic of an embodiment of the light engine of the present invention;

FIG. 11 is a blown up view of an upper right portion schematic of FIG. 6;

FIG. 12 is a blown up view of a lower right portion of the schematic of FIG. 6;

FIG. 13 is a blown up view of a left portion of the schematic of FIG. 6;

FIG. 14 is a schematic of an embodiment of a control section of a light engine of the present invention;

FIG. 15 is a blown up view of a bottom portion of the schematic of FIG. 14;

FIG. 16 is a blown up view of a left portion of the schematic of FIG. 14;

FIG. 17 is a blown up view of an upper right portion of the schematic of FIG. 14;

FIG. 18 is a schematic of an embodiment of a light engine of the present invention having multiple colored LEDs;

FIG. 19 is a blown up view of a left portion of the schematic of FIG. 18;

FIG. 20 is a blown up view of a right portion of the schematic of FIG. 18;

FIG. 21 is a schematic of an embodiment of the present invention having four LEDs;

FIG. 22 is a blown up view of a left portion of the schematic of FIG. 21;

FIG. 23 is a blown up view of a top portion of the schematic of FIG. 21;

FIG. 24 is a blown up view of a bottom portion of the schematic of FIG. 21;

FIG. 25 is a blown up view of a right portion of the schematic of FIG. 21;

FIG. 26 is a schematic of an embodiment of the primary controller of the present invention;

FIG. 27 is a blown up view of a bottom left portion of the schematic of FIG. 26;

FIG. 28 is a blown up view of a center portion of the schematic of FIG. 26;

FIG. 29 is a blown up view of a bottom portion of the schematic of FIG. 26;

FIG. 30 is a blown up view of a lower right portion of the schematic of FIG. 26;

FIG. 31 is a blown up view of a top left portion of the schematic of FIG. 26;

FIG. 32 is a blown up view of a top right portion of the schematic of FIG. 26;

FIG. 33 is a schematic of a control link of an embodiment of the present invention;

FIG. 34 is a blown up view of a lower left portion of the schematic of FIG. 33;

FIG. 35 is a blown up view of a lower right portion of the schematic of FIG. 33;

FIG. 36 is a blown up view of an upper left portion of the schematic of FIG. 33;

FIG. 37 is a schematic of an embodiment of a secondary controller of the present invention;

FIG. 38 is a blown up view of a lower left portion of the schematic of FIG. 37;

FIG. 39 is a blown up view of an upper portion of the schematic of FIG. 37;

FIG. 40 is a blown up view of a bottom portion of the schematic of FIG. 37;

FIG. 41 is a blown up view of a right portion of the schematic of FIG. 37; and

FIG. 42 is a flow chart of the light engine illumination data transformations of an embodiment of the present invention.

### DETAILED DESCRIPTION OF A PREFERRED EMBODIMENT OF THE PRESENT INVENTION

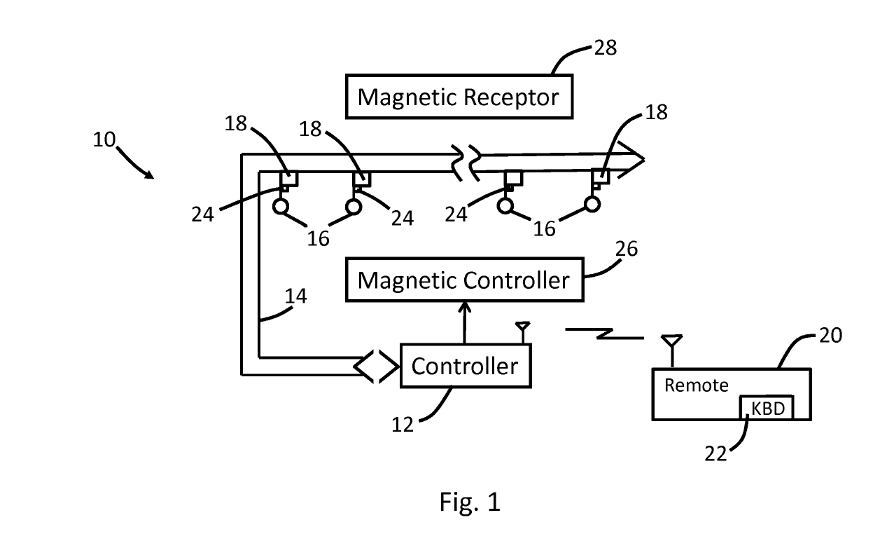

With reference first to FIG. 1, a block diagrammatic view of a lighting system 10 in accordance with the present invention is shown. The lighting system 10 includes a digital controller 12 which preferably is microprocessor controlled. The controller 12 communicates through a bidirectional bus 14 to a plurality of lights 16 in the lighting system 10. The lights are preferably solid state lights (SSLs) known to those skilled in the art, e.g. light emitting diode (LED) lights. In addition, the SSLs can be a solid state light developed in the future.

Still referring to FIG. 1, a logic circuit 18 is associated with each light 16 or group of lights 16. The logic circuit 18 decodes an address signal from the bidirectional bus 14 in order to determine if a command signal on the bidirectional bus 14 is directed to that particular light. For example, if the controller 12 generates an output signal along the bidirectional bus 14 to a light at a particular address to increase the illumination of that particular light, the logic circuit 18 associated with that particular address will decode the address on the bus 14 and increase the illumination of its associated light 16 in accordance with the command. Naturally, other types of commands may also be directed to the lights 16 and the commands from the controller 12 themselves may be directed to both individual lights 16 as well as group of lights 16. Another example of a command to the light 16 from the controller would be a command to flash that particular light.

In order to generate the appropriate commands from the controller 12, a remote control unit 20 wirelessly communicates with the controller either through radio signals, light signals, or sound signals. The remote control 20 itself includes a keyboard 22 or other data input unit, e.g. a joystick, to select the command to be generated by the controller to the lights 16 in the lighting system.

The bus 14 is bidirectional and conveys both commands from the controller 12 to the lights 16 as well as operating characteristics of the lights 16 back to the controller 12. For example, a temperature sensor 24 is preferably associated with each light 16 and generates an output signal through its associated circuit 18 back to the controller 12 indicative of the operating condition of the light. This operating condition can include not only whether the light 16 is on or off, but also the intensity of the light, temperature of the light, and so forth. In response to these input signals from the light circuits 18, the controller 12 generates the appropriate commands to the individual lights 16 in order to change their on/off state, intensity, and/or the light, as well as to control the temperature of the lights 16.

The control of the temperature of the lights 16 forms an important aspect of the present invention. In some situations, the housings for the lights 16 may be snow covered or otherwise obscured. In those situations, the controller 12 generates an output signal to that individual light 16 to increase the intensity of the light 16, and thus the temperature of the light 16 in order to melt the snow. In other situations, the temperature of the light 16 may be too high and form a possible hazardous condition. In those situations, the controller 12 generates a command signal to the address of the light together with a command to reduce the intensity of the light and thus reduce the temperature of the light 16.

In some situations, it is desirable to reprogram all of the addresses decoded by the circuits 18 associated with the lights 16. In order to achieve this, a magnetic controller 26, under command of the main controller 12, generates a magnetic signal that is detected by a magnetic receptor 28 adjacent the lights 16 in the lighting system 10. The magnetic receptor 28 erases all of the addresses contained in the circuits 18 associated with the lights 16. The controller 12 then generates command signals along the bidirectional bus 14 to the circuits 18 for the lights 16 in order to reprogram the addresses of the lights 16, either individually or as a group.

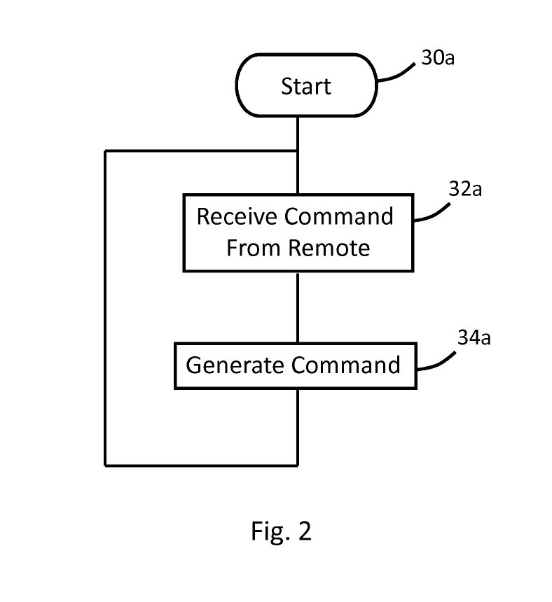

With reference now to FIG. 2, a flowchart is illustrated showing the basic operation of the present invention. After initiation of the program at step 30, step 30 proceeds to step 32. At step 32, the controller 12 receives the input signal from the remote control 20 indicative of the type of command for the controller 12 to generate and transmit along the bidirectional bus 14. Step 32 then proceeds to step 34 in which the controller 12 generates the command to the circuits 18 associated with the lights 16. Optionally, the circuits 18 respond back to the controller 12 indicating the proper receipt of the command signal so that the command signal can be retransmitted if necessary.

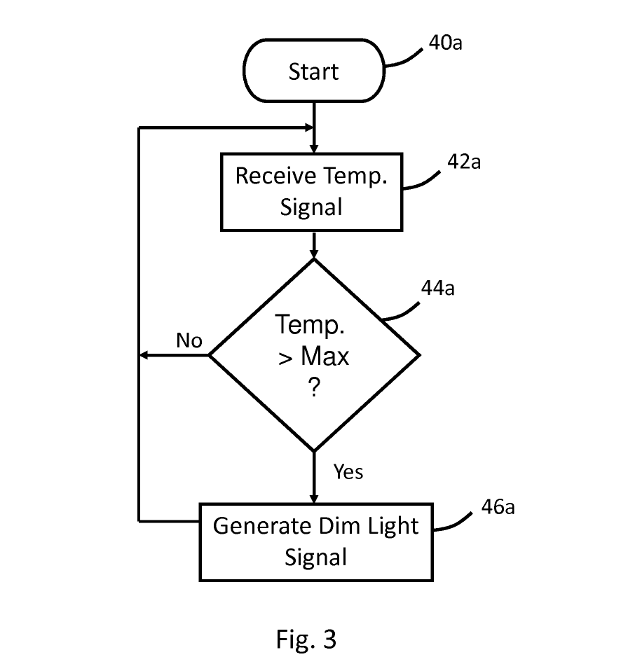

With reference now to FIG. 3, a still further flowchart is illustrated for the temperature control of the lights 16. After initiation of the program at step 40, step 40 proceeds to step 42.

At step 42, the controller 12 receives a signal from one or more of the circuits 18 associated with the lights 16 representative of the temperature of the sensor. Step 42 then proceeds to step 44.

At step 44, the received temperature signal is compared by the microprocessor in the controller 12 with a maximum temperature. If the temperature of the light is less than the maximum temperature, step 44 merely branches back to step 42 where the above process is repeated.

Otherwise, step 44 proceeds to step 46 where the controller 12 generates a command coupled with an address to the appropriate light 16 to dim the intensity of the light 16. By dimming the intensity of the light 16, the temperature of the light 16 also decreases. Step 46 then branches back to step 42 and the above process is repeated.

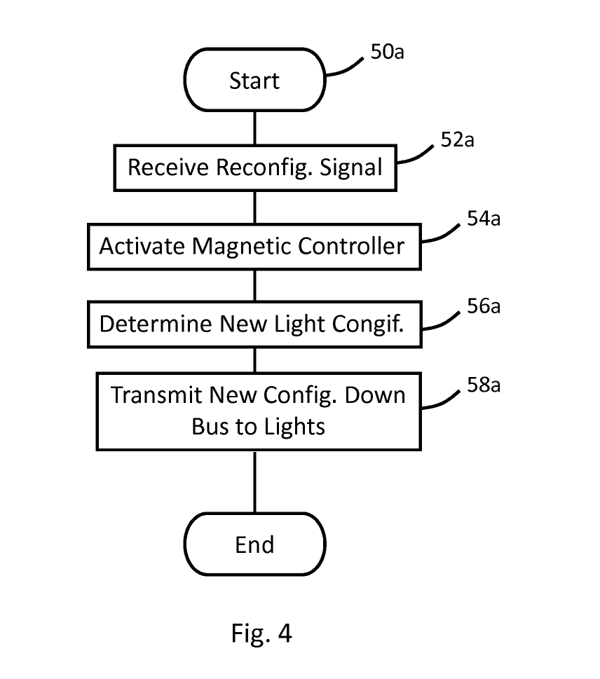

With reference to FIG. 4, a flowchart is shown indicating the reconfiguration of the addresses for the lights 16. After initiation of the program at step 50, step 50 proceeds to step 52.

At step 52, the controller 12 receives a command signal from the remote 20 to reconfigure the addresses of the lights 16 and then proceeds to step 54. At step 54, the controller activates the magnetic controller 26 which generates a magnetic field. That magnetic field is detected by the magnetic receptor 28 which erases the addresses for the lights in the circuits 18. Step 54 then proceeds to step 56.

At step 56, the controller determines the new configuration 56 from the commands received by the controller 12 from the remote control 20. Step 56 then proceeds to step 58 and transmits the new address configurations for the lights 16 along the bidirectional bus 14 to the circuits 18 associated with the lights 16. Upon receipt by the circuits 18, the addresses for the lights 16, or groups of lights 16, are reconfigured for subsequent control in the lighting system 10.

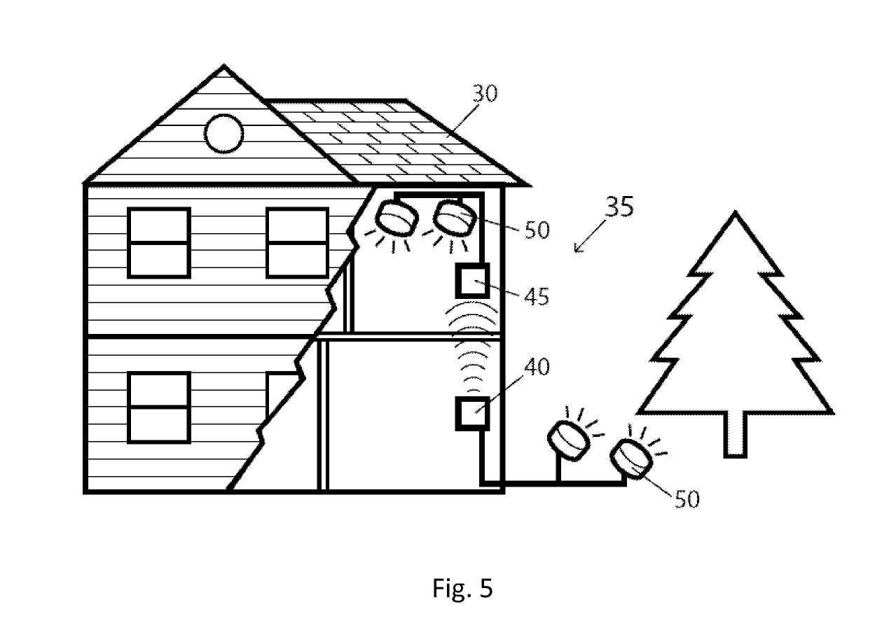

In addition to the above, FIG. 5 shows a building 30 having a light engine control system 35 of the preferred embodiment. The light engine control system 35 can include a primary controller 40, one or more secondary controllers 45, the primary controller 40 and secondary controller 45 being in wired or wireless communication with each other. This communication can be two way. The wireless communication can be achieved through a traditional Wi-Fi network or through a specialized wireless network, such as a Zigbee control system or any other wireless method known to those in the art.

The primary controller 40 and secondary controller 45 can be wired to one or more light engines 50. In this arrangement, the primary controller 40 and secondary controller 45 are bus masters, which initiate all communication by transmitting commands. The individual light engines 50 are nodes on the network, or bus slaves, which receive commands and may transmit replies. The lights may be used inside or outside the building 30, and the building 30 may be of residential, industrial or commercial space. In addition, it is appreciated that the light engine control system 35 is not limited to the situations shown; rather, the light engine control system 35 may be used in any situation as where lighting is desired.

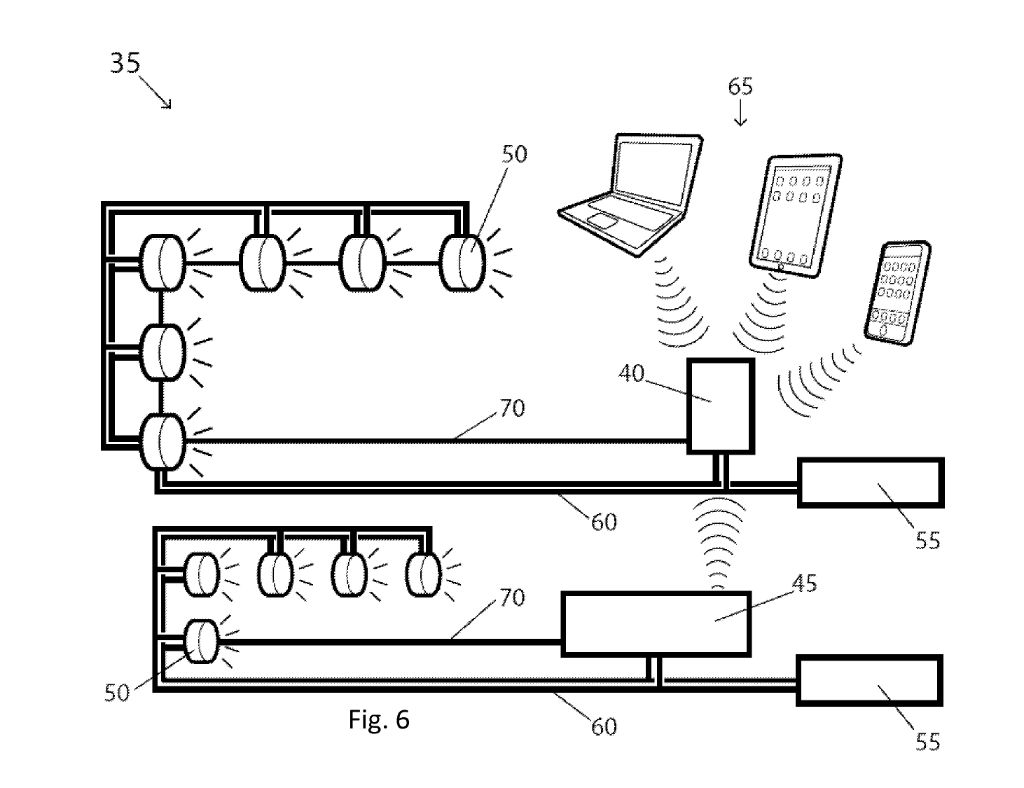

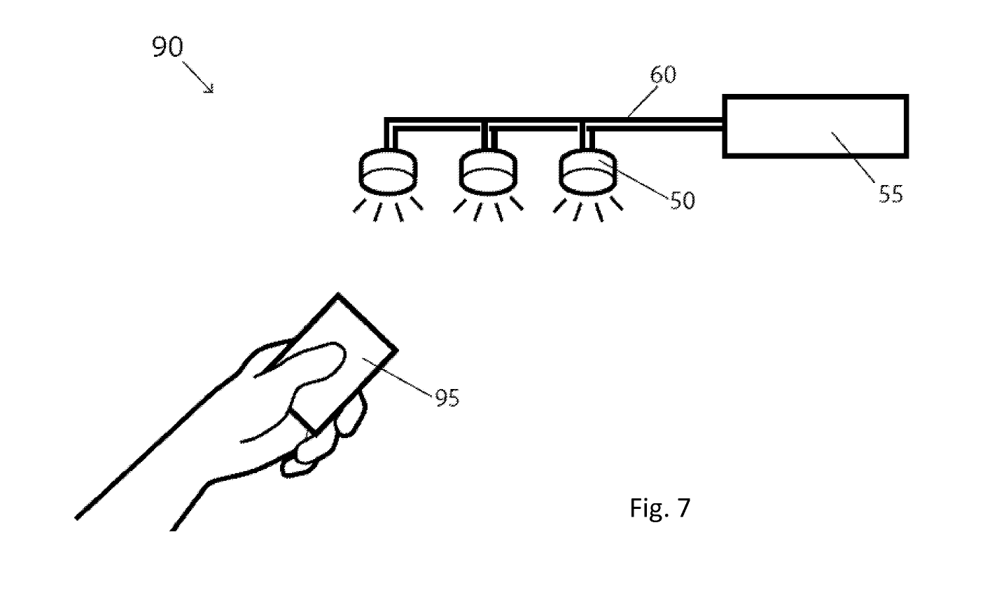

Turning now to FIG. 6, the light engine control system 35 of the preferred embodiment is shown. The light engine control system 35 may be controlled by a user input from a wireless control device 65, such as a laptop, tablet or smart phone and other devices of the like. The wireless control device 65 can be operable to send instructions to the primary controller 40, the primary controller 40 being connected to a set of the light engines 50. Additionally, the primary controller 40 can be in wired or wireless communication with one or more of the secondary controllers 45, the secondary controller also being wired to a set of the light engines 50.

The primary controller 40 and the secondary controller 45 are in communication with the set of light engines 50 through a three-wire control system, the three-wire control system including a two wire power connection 60 and a single control wire 70. The primary controller 40, the secondary controller 45 and the light engines 50 all receive power from a power supply 55, which is in electrical communication with the elements through the two wire power connection 60. The power supply 55 can be either a direct current power supply or an alternating current power supply.

To control the lighting characteristics of the light engines 50, the primary controller 40 and secondary controller 45 are operable to send a signal which includes a packet of information through the single control wire 70. This packet can be received by all of the light engines 50 on the wired network. A packet which is received by all of the light engines 50 can include one or more specific addresses portions, which is received by the light engines 50. If the address portion of the packet corresponds to the light engines 50 having a specific address included in the packet, the light engine 50 responds to the command portion of the packet. Upon receipt of the command, the light engine 50 is operable to adjust light characteristics of light produced by the light engine 50 to conform to the command portion of the packet. The light engine 50 can also send an acknowledgment signal including a packet of information back to the primary controller 40 or the secondary controller 45. The light engine 50 can also provide an acknowledgment flash by either turning the LEDs of the light engine on or off, or flashing the LEDs. A packet received by a controller can be retransmitted to continue through the network. This allows the primary controller 40 or the secondary controller 45 to group and regroup the light engines as the user sees fit without having to rewire or reprogram the light engines 50.

In addition to sending a packet with the specific address portion and the command portion, the primary controller 40 or the secondary controller 45 can send out a broadcast command packet to control all the light engines 50 on the light engine control system 35.

The method for setting up or conditioning the light engine control system 35 includes providing and installing the primary controller 40 with light engine 50 network. A secondary controller may also be provided and installed. A magnet tool 95 can be held close to the specific light engine 50 to be setup into the light engine control system 35. The primary controller 40 and the be instructed to search for a new light engine 50 on the network, which will be identified by sensing the magnetic tool 95 being held near the specific light engine 50. The primary controller 40 can then associate the identified light engine 50 with a specific and individual address. This method can be repeated after initial setup or conditioning, should additional light engines 50 or controllers be added to a light engine control system 35.

The primary controller 40 and secondary controller 45 are operable to control the characteristics of the light which is produced by the light engines 50. The primary controller 40 and secondary controller 45 can be programmed to automatically adjust the light color, temperature, brightness and hue to better conform to the user's preferences. For example, a light brightness and temperature can be set to match the time of day, depending on if there is a lot of natural coming into the lighting environment, if it's dark outside, if it is time to wake up, or nearing time to go to sleep. Additionally the light engines 50 can be set to conform to various activities routinely done during the day, such as working on a computer, reading, relaxing, watching television or doing other work requiring different lighting environments.

The wireless control device 65, primary controller 40 and secondary controller 45 can also be operable to know what type of LED is installed in the lighting engine, thereby enabling proper control and output from the LED. For example, if a light engine 50 having single color LEDs is installed, light engine control system 35 can detect only single colors LEDs and limit the options presented to a user when requesting different light characteristics, and also may limit the commands sent to the light engine 50 having a detected LED type to those commands which the light engine 50 having a detected LED type can perform.

It is appreciated that the light engine control system 35 can include just the primary controller 40 and wired light engines 50. One or more of the secondary controllers 45 and wireless control devices 65 may be added based situational and user requirements and preferences.

Information is communicated in a light engine control system 35 as packets of data. All devices, including the wireless control device 65, primary controller 40, the secondary controller 45, and light engines 50 connected to a lighting network receive all packets that are transmitted. The receiving device, a controller 40, 45, 65 or a light engine 50, determines whether to accept a packet not. Controllers 40, 45, 65 which may operate as network bridges which can selectively retransmit commands which originate on one sub-network to different sub-network.

The networks transport medium may be wired or wireless. The wired connection uses the single control wire 70 and the protocol is half-duplex; information is communicated in two directions but in only one direction at a time. The wireless transport can be by WiFi, ZigBee or other methods known in the art.

There are two types of packet, command, and reply. Command packets are transmitted from the lighting controller 40, 45, 60 to one or more light engines 50. Reply packets are transmitted from the light engine 50 in response to command packets which uniquely address that light engine 50.

A command packet consists of an address, command code, parameters, which may vary in number or may be omitted altogether, and validation data. Validation data is used to assure that the content of the packet is correctly received. The validation may be by checksum, cyclic redundancy, or other commonly employed algorithm known to those skilled in the art.

There are three types of command packet address. A broadcast address is used to transmit command packets which are received, accepted, and processed by all light engines 50. Light engines 50 do not transmit a reply packet for broadcast-addressed commands. A zone address is used to transmit command packets to a subset of the light engines 50. Light engines 50 do not transmit a reply packet for zone-addressed commands. A light engine address is used to send a command to a specific light engine 50. The addressed light engine normally transmits a reply packet for light-engine-addressed commands, although there is a parameter flag which is used to inhibit these replies when they are not needed or desired.

Each light engine 50 has a list of addresses that it uses to determine whether to accept a command packet and perform the command in that packet. This address list includes: the broadcast address value used by all light engines 50 in a light engine control system 35, one or several zone address values, in the current implementation there are up to four zone address values, and the light engine address value, which is normally a value unique for each light engine 50 in the light engine control system 35.

The command code identifies the type of operation that the light engine 50 is to perform. There are many different commands, but the four primary types of command are network control and configuration commands, lighting control commands, status and operating state commands, and diagnostic commands. It is understood that this list of command codes is not meant to be limiting, but rather serves as an example of some of the many possible command codes.

The two possible examples of network commands include the poll command, and the set light engine address command.

The poll command is used to detect the presence or absence of a specific light engine 50. The poll command packet consists of a light engine address, the poll command code, and validation data. The light engine 50 addressed by the poll command transmits the reply packet which consists of the light engine address and validation data. Assuming that each light engine 50 on the light engine control system 35 network has a unique light engine address, then no other light engine will reply to the poll command.

The set light engine address command is used to change a light engines unique address. The command consists of the light engines current address, the command code, the light engines new address, and validation data. When accepted by a light engine 50, the light engine 50 replies with its new address and validation data. The address change takes immediate effect.

These two commands, poll, and set light engine address, have different behavior when a light engine's magnetic proximity sensor is activated in the presence of a strong magnetic field, such as that produced by the magnetic tool 95.

As mentioned above, light engines 50 to not normally reply to commands which use the broadcast address. A poll command packet sent using the broadcast address will not receive a reply packet from any light engine 50. The exception to this is that a light engine 50 that has its magnetic proximity sensor activated, for example with the magnetic tool 95, will reply to the broadcast-addressed poll command with a reply packet containing the light engine's address. In addition to this, while the light engine 50 has its magnetic proximity sensor activated it will not reply to a poll command that uses the engines own light engine address.

These behaviors allow a controller 40, 45, 65 to differentiate between light engines 50 which may have identical light engine addresses. Having more than one light engine 50 with the same address may occur during network commissioning; or when additional light engines 50 are installed; or when other changes to the light engine control system 35 or light engines 50 in the network are performed.

As with the poll command, the set light engine address command, if sent as a broadcast-addressed command packet, is not replied to, and is also not accepted and performed by any light engine 50. The exception to this is that a light engine that has its magnetic proximity sensor activated, for example with the magnetic tool 95, will both accept and reply to the broadcast set light engine address command. This allows the controller 40, 45, 65 to change the address of the magnetically activated light engine, but not also change the address of a different light engine 50 which may have had the identical light engine address.

A controller 40, 45, 65 can be placed into a network commissioning mode where it transmits poll commands using both the light engine addresses, and the broadcast address, and then use the set light engine address command to re-number light engines 50 when multiple engines are detected having the same light engine address. While the controller 40, 45, 60 is in network commissioning mode, the magnetic tool 95 which consists of a strong magnet or other type of strong magnetic field generator is brought into close proximity with each light engine 50, one engine at a time.

When the controller 40, 45, 65 receives a reply to a broadcast poll command, the controller 40, 45, 65 then knows that that light engine 50 is the magnetically activated light engine. The controller 40, 45, 65 immediately transmits a non-broadcast poll command using that light engines address. If no other light engine 50 is using that same address, there will be no reply since the magnetically activated light engine will not reply to the light engine addressed poll command. If there is a reply then the controller 40, 45, 65 knows that there are multiple light engines 50 using that address. The controller 40, 45, 65 then transmits a broadcast-addressed set light engine address command with a new, currently unused address. Only the magnetically activated light engine accepts this command and changes its light engine address.

During commissioning, the controller 40, 45, 65 and light engine 50 use the light engine 50 illumination to signal when to move the magnetic tool 95 to the next light engine 50. When the light engine 50 is initially magnetically activated the illumination will turn on if the illumination was currently turned off. If the illumination was currently on, the illumination will turn off. This is a visual indication that the magnetic activation was successful. As the controller 40, 45, 65 performs the poll operation and possible re-numbering operation it will cause the light engine 50 to flash or blink. The speed of the blinking can be varied. For example, a fast blink can be a signal that the operation is completed and the tool can be removed from the light engine. On multi-colored engines, different colors may be used to signal.

As discussed infra, the magnetic proximity sensor and magnetic tool 95 may be used to configure the illumination intensity and possibly the color that the light engine 50 outputs when it is powered on. But when performing the network commissioning operation, the magnetic activation should not affect the illumination configuration. The light engine uses the reception of poll messages to determine which operation to perform then the magnetic sensor is activated. While poll messages are being received, the magnetic sensor is used for network commissioning mode operation and the magnetic illumination configuration operation is inhibited. After no poll messages have been received for a period of time, the magnetic illumination configuration operation is re-enabled.

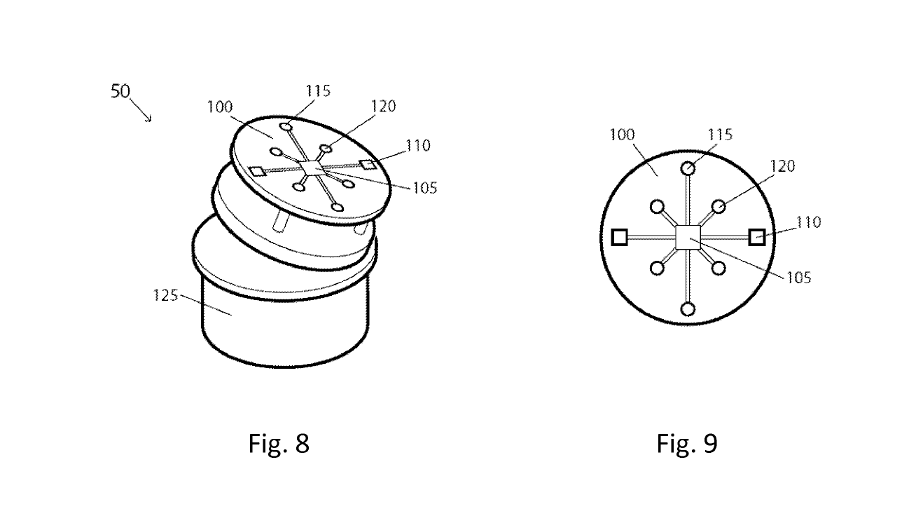

Turning now to FIG. 8, an alternate light engine control system 90 is shown. The alternate light engine control system 90 provides an easily programmable light engine control system without the need of an electronic master controller, such as the primary controller 40 or the secondary controller 45. The alternate light engine control system 90 features the power supply 55 connected by the two power wire connection 60 to a series of light engines 50. The light engines 50 have a magnetic sensor control device not shown, which can detect when the magnetic tool 95 is placed within close proximity to the individual light engines 50.

The individual light engines 50, having a magnetic sensor, can be operated to respond to the magnetic tool 95 when the magnetic tool 95 is within close proximity to the individual light engines 50. The light engine 50 can alter the light output settings of the LEDs based various time durations of holding the magnetic tool 95 within close proximity to the individual light engines 50. For example, by placing the magnetic tool 95 close to the individual light engine 50 for a set duration, for example two seconds, the light engine 50 can dim by one level. In addition, if the magnetic tool 95 is held near the light engine 50 for a longer duration, it can cause the light engine to output its current brightness level. It can be appreciated that using different durations of time with the magnetic tool 95 enables different settings to be adjusted in the light engine 50. These different settings can include the brightness, hue, color, temperature, etc.

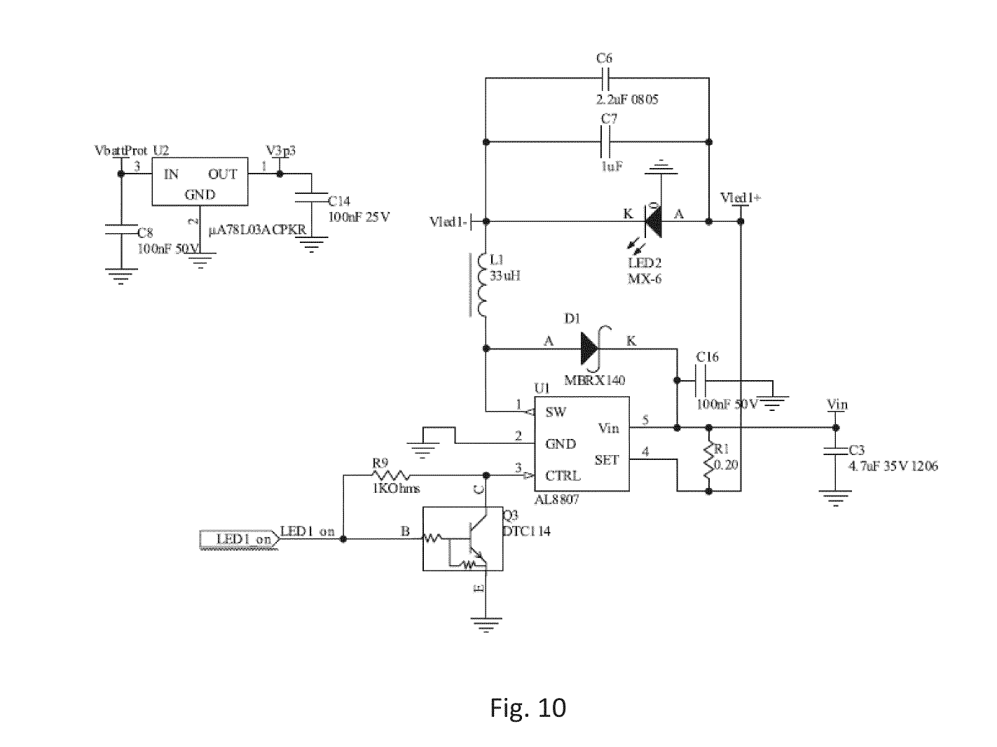

Turning now to FIG. 10, the light engine 50 of the present invention is shown. The light engine 50 includes a circuit board 100. On the circuit board 100 is one or more of a control module 105, a temperature sensor 110, a heating element 115 and LEDs 120. The circuit board 100 can be installed in a housing 125 of the light engine 50. The temperature sensor 110 and heating element 115 may be located on the circuit board, provided that they are in thermal communication with the housing element 125. It is appreciated that in the alternative to being mounted directly on the circuit board 100, the temperature sensor 110 and heating element 115 could be mounted to the housing 125 and wired back to the circuit board 100. The circuit board 100 receives power from the two wire power connection 60 previously discussed and can also receive the single control wire 70. The two wire power connection 60 and the optional control wire 70 can be received by the control module 105, the control module 105 being in electronic communication with the temperature sensor 110, the heating element 115 and the LEDs 120. The temperature sensor 110 is operable to determine the temperature of the housing 125, either through the direct connection of the temperature sensor 110 to the housing 125 or through an alternate thermal-coupled surface between the circuit board 100 and the housing 125.

The heating element 115 can also be mounted directly to the housing 125 or mounted on the circuit board 100, provided the circuit board 100 with heating element 115 is in thermal communication to with the housing 125.

The control module 105 is operable to receive a temperature input from the temperature sensor 110. The control module 105 can then use this temperature input to determine whether or not to activate the heating elements 115 or to reduce power to the LEDs 120.

Should the control module 105 determine that the housing 125 is below a specified temperature threshold, for example, below a freezing temperature, the control module 105 can activate the heating element 115 to increase the temperature of the housing 125, thereby melting snow, ice and the such which may have been accumulated on the outside of the housing 125 and which may interfere with transmission of the light produced by the LEDs 120.

Should the control module 105 determine that the housing 105 temperature is above a threshold limit, for example, a building code standard, the control module 105 is operable to reduce power to the LEDs 160, thereby reducing the temperature of the housing 125 to within the set parameter limits. It is appreciated that the light engine 50 of the present invention can include a single or plurality of the temperature sensor 110, the heating element 115 and the LEDs 120, these components being in various locations within or on the housing 125 or may be directly attached to the circuit board 110.

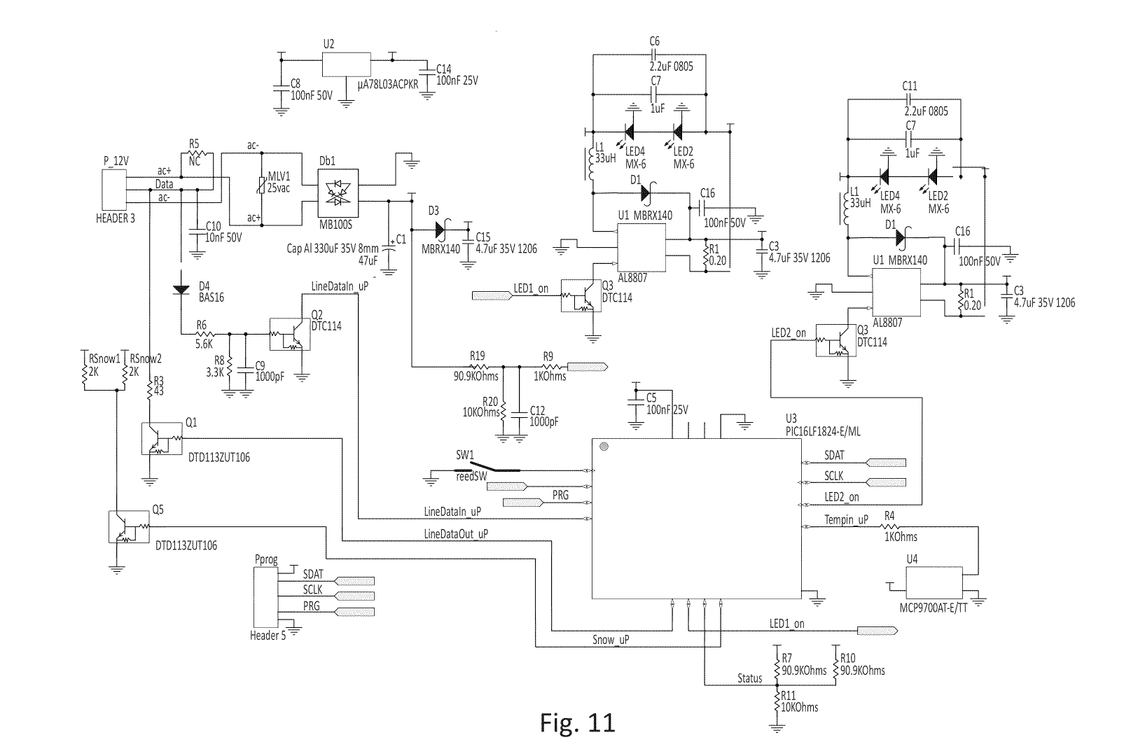

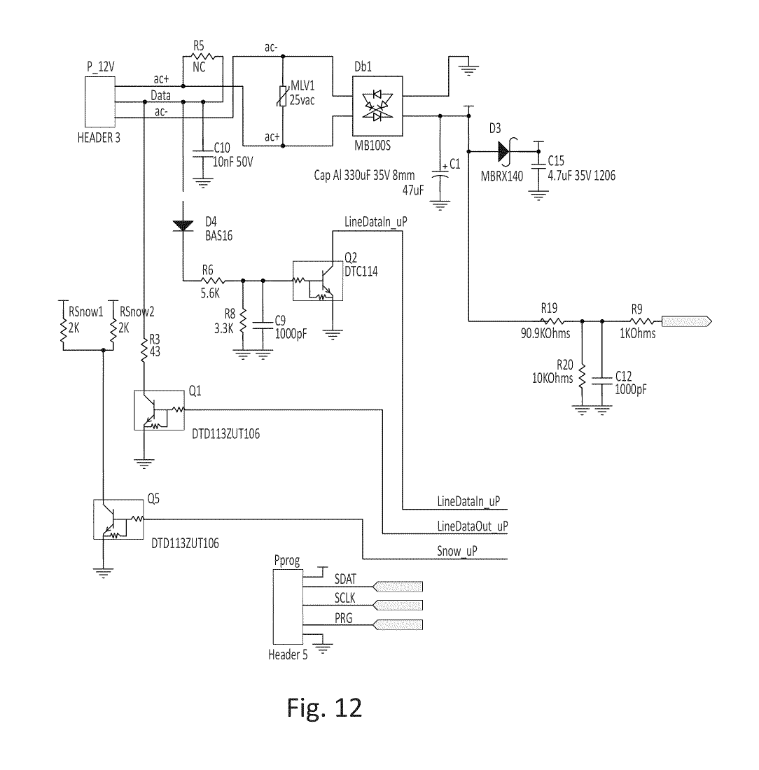

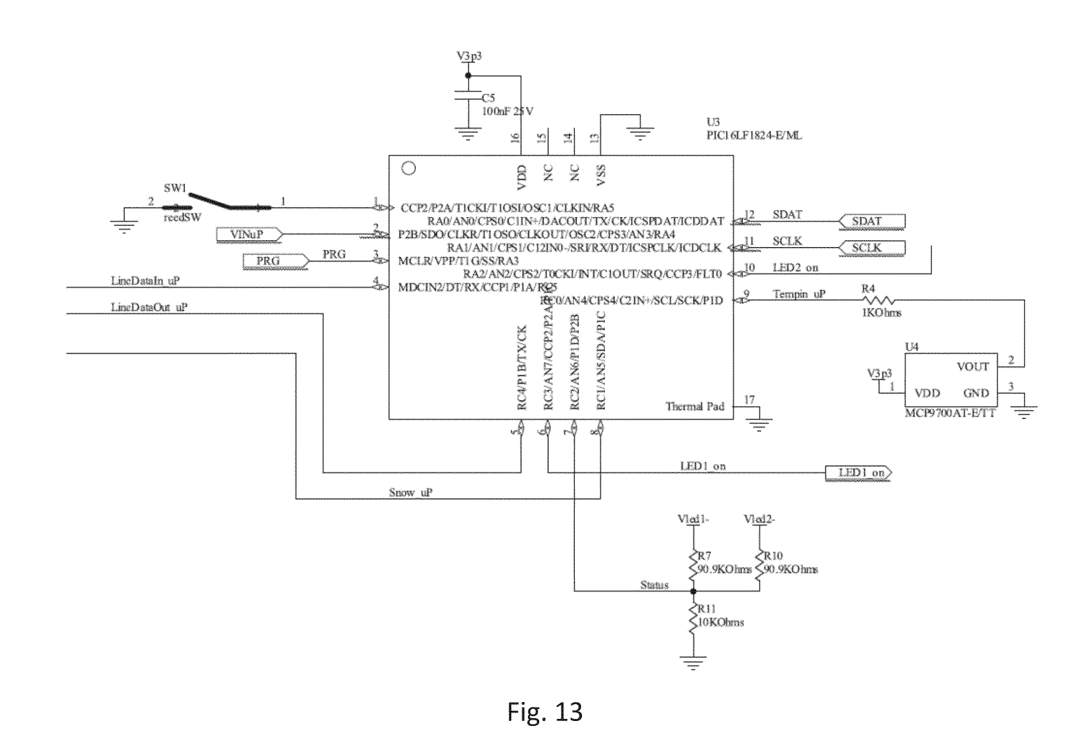

FIGS. 10 through 13 show a schematic for a light engine 50 of the present invention having a single LED.

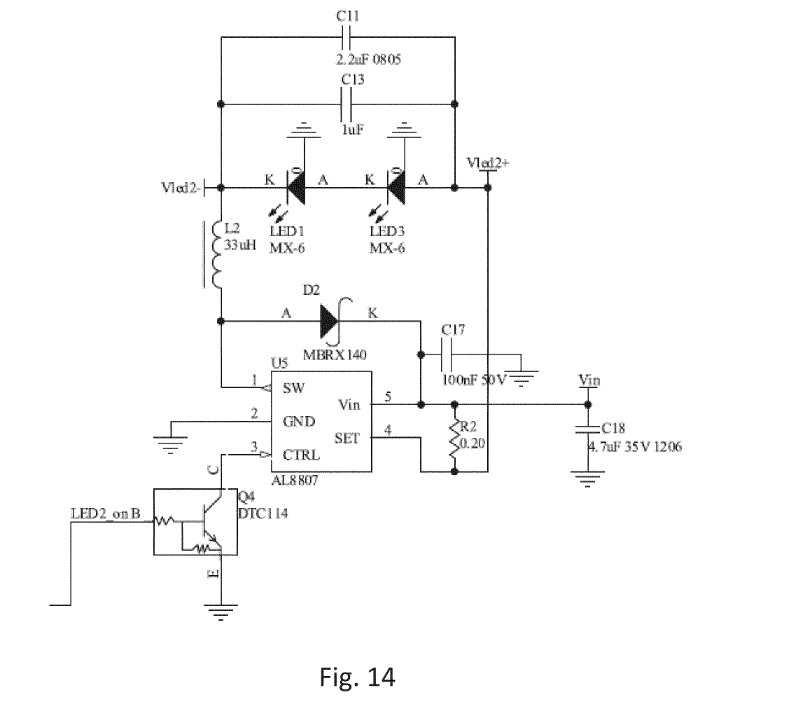

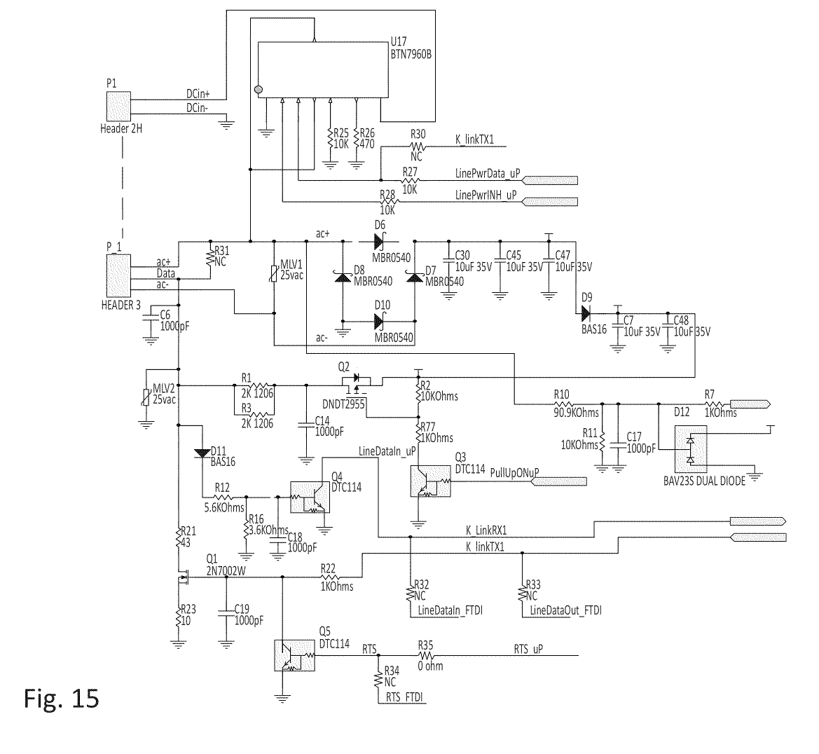

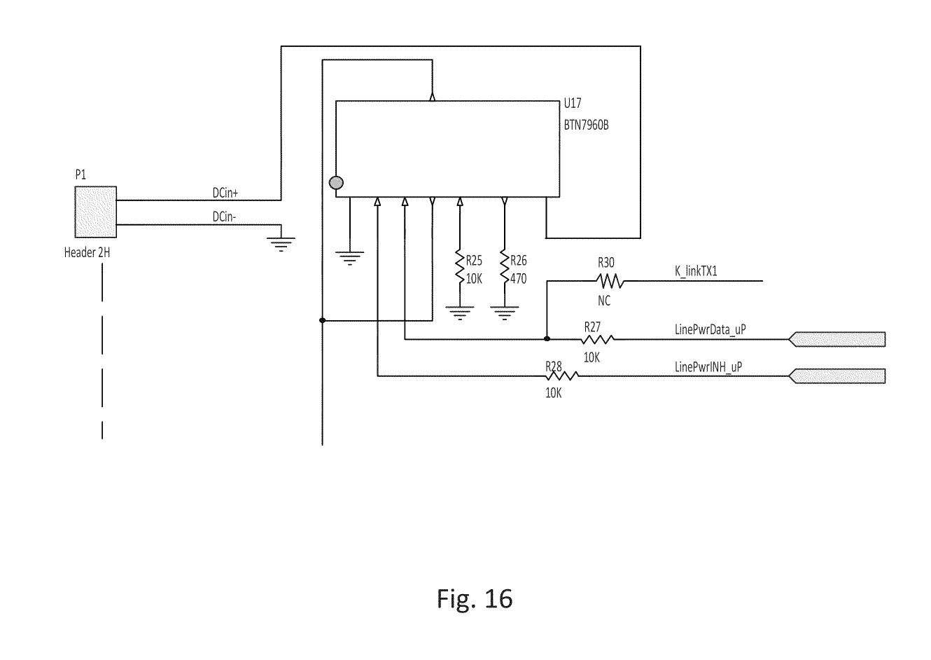

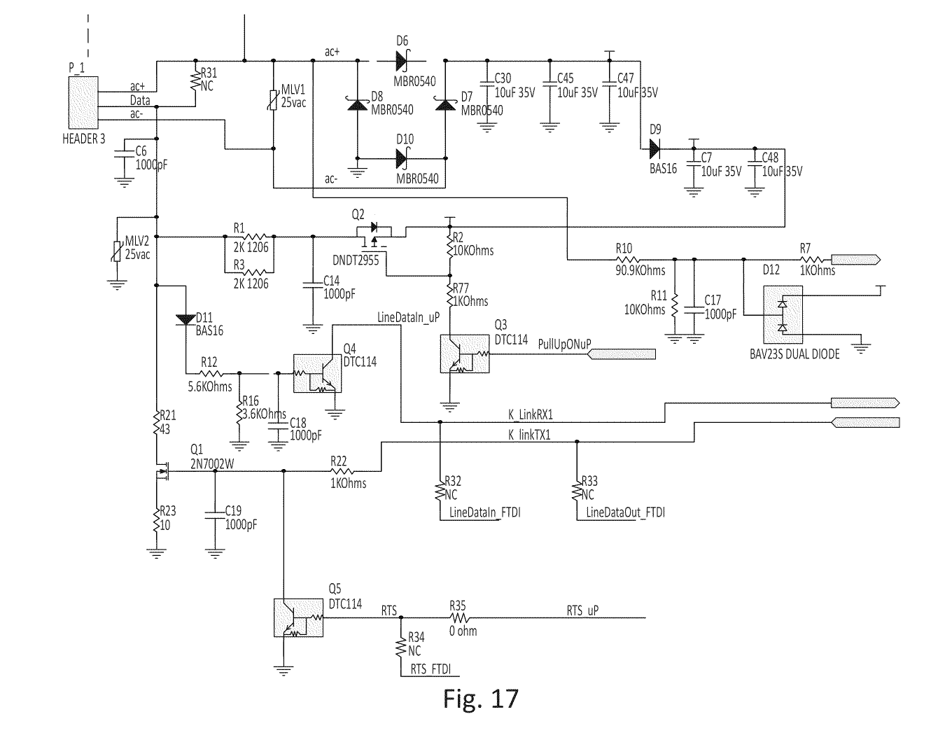

FIGS. 14 through 17 show a schematic of a light engine 50 of the present invention before the addition of an LED. This schematic can be used to produce a light engine 50 operable to accept any LED to practice the present invention.

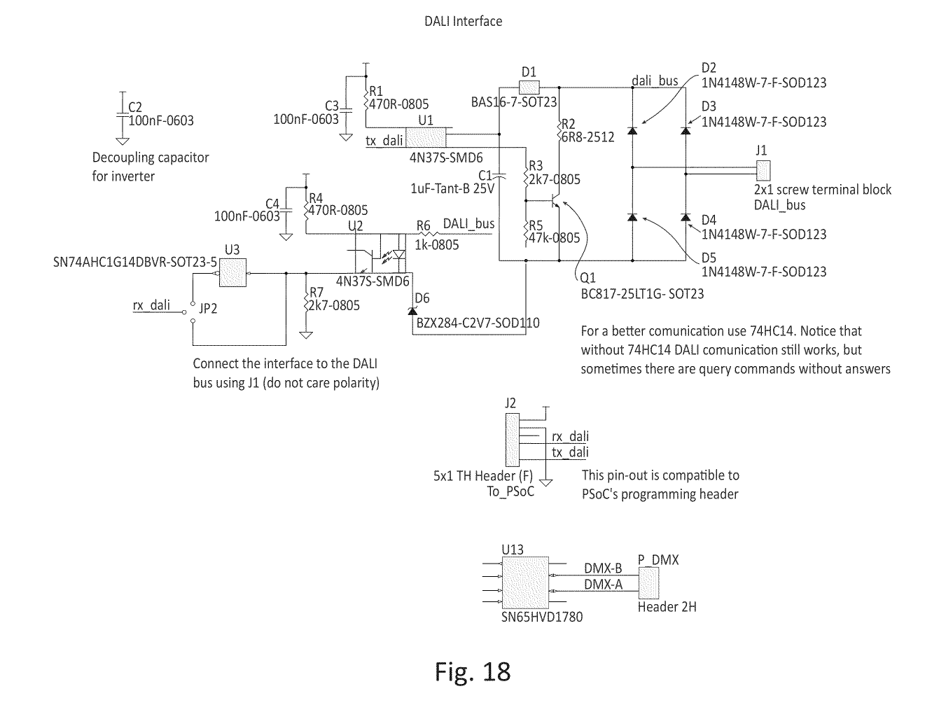

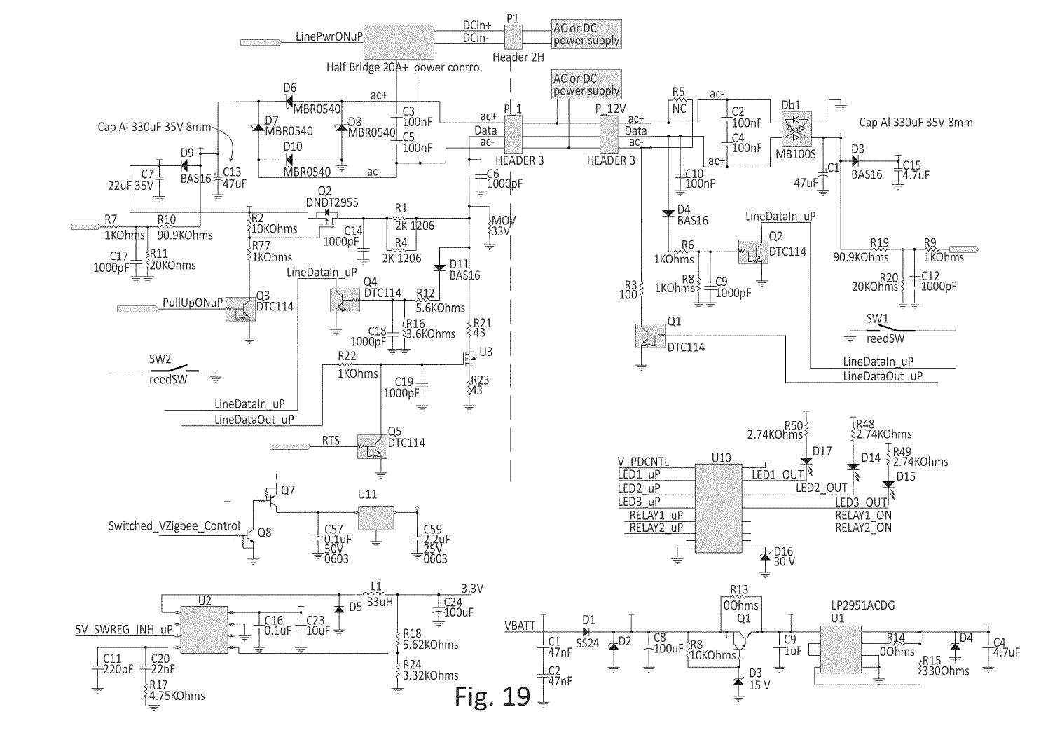

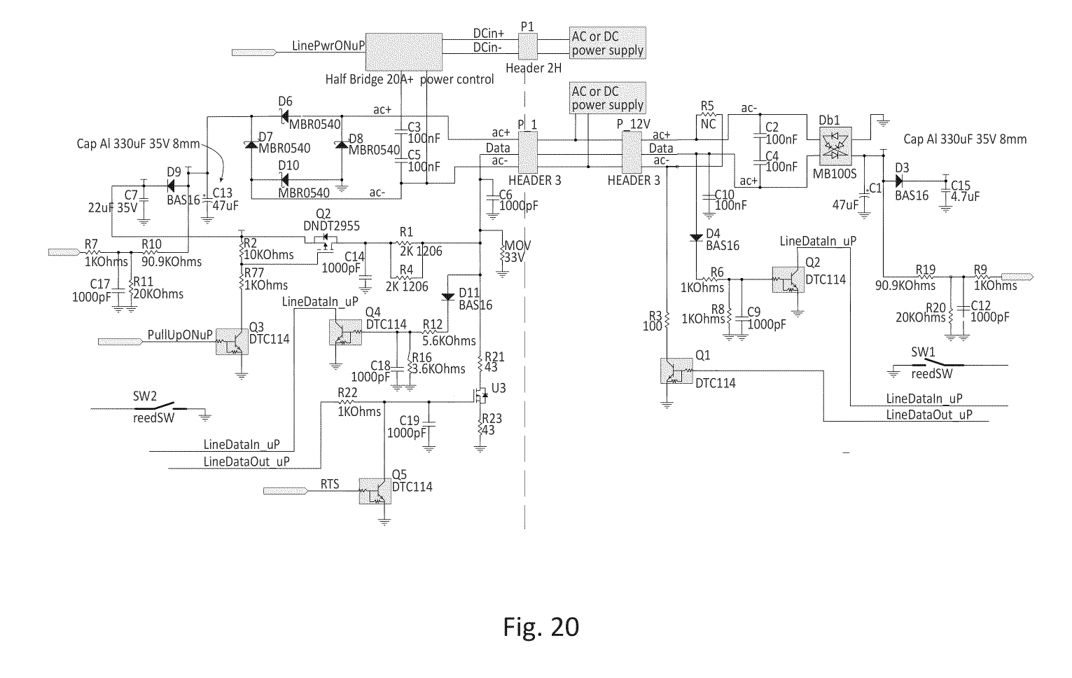

FIGS. 18 through 20 show a schematic of a light engine 50 of the present invention featuring red, green, blue and white LEDs. A light engine 50 produced using this schematic is operable to allow full control of the light color, hue, saturation, brightness, temperature etc.

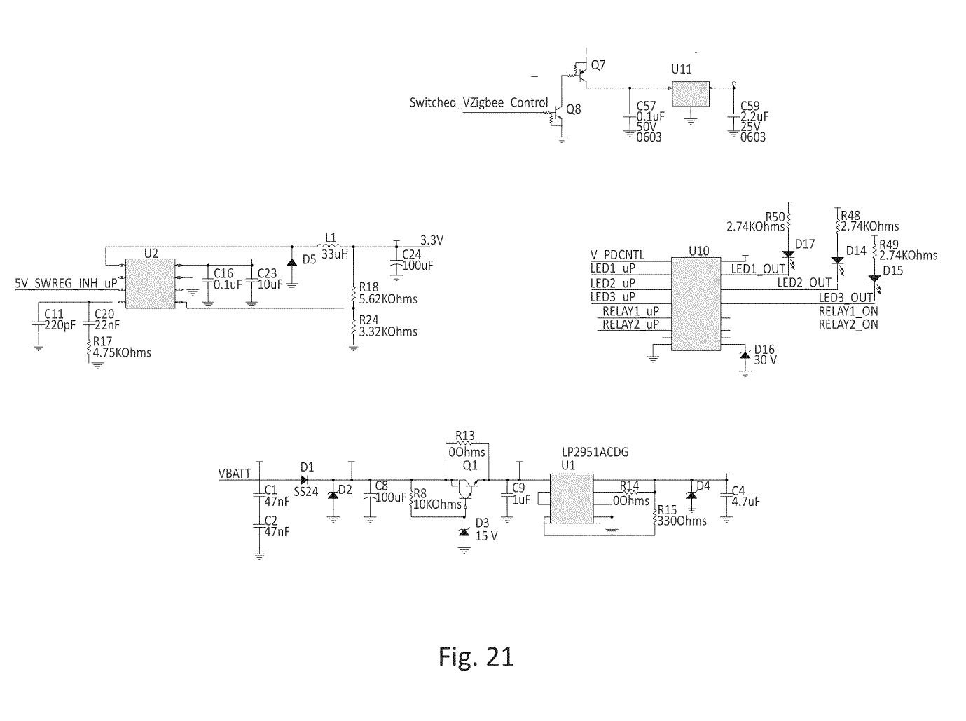

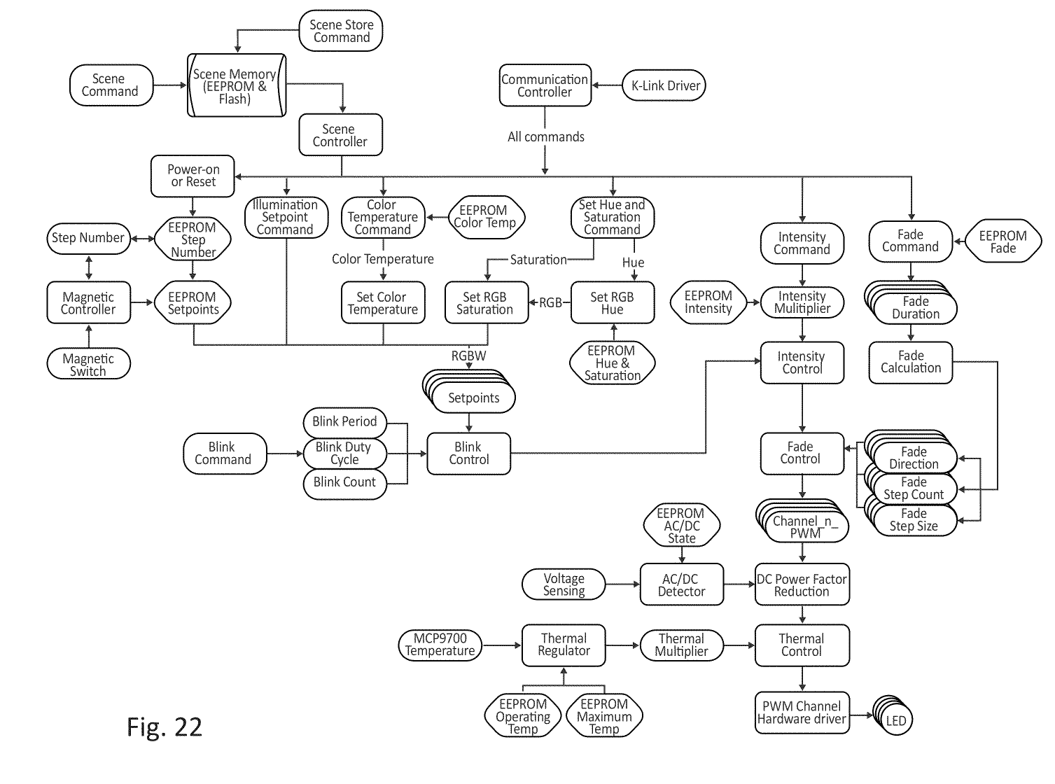

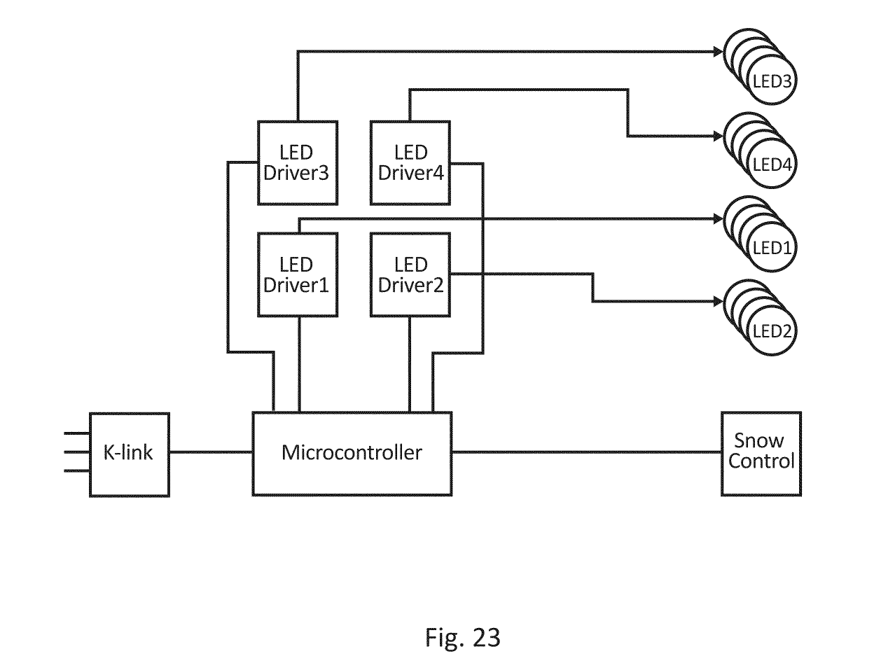

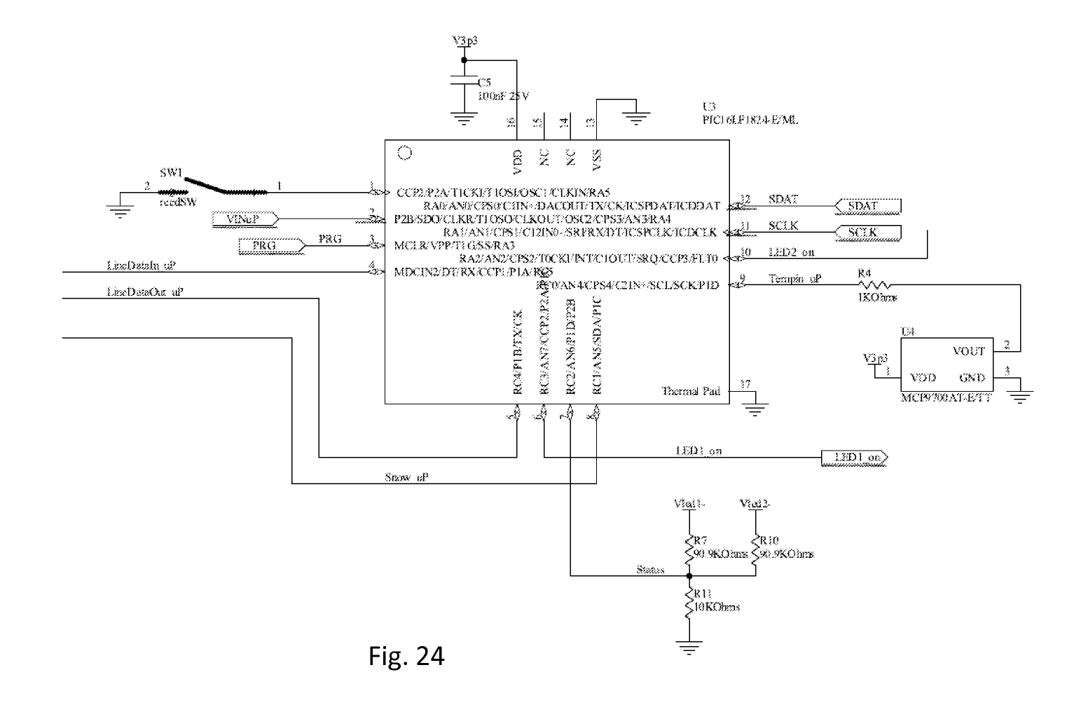

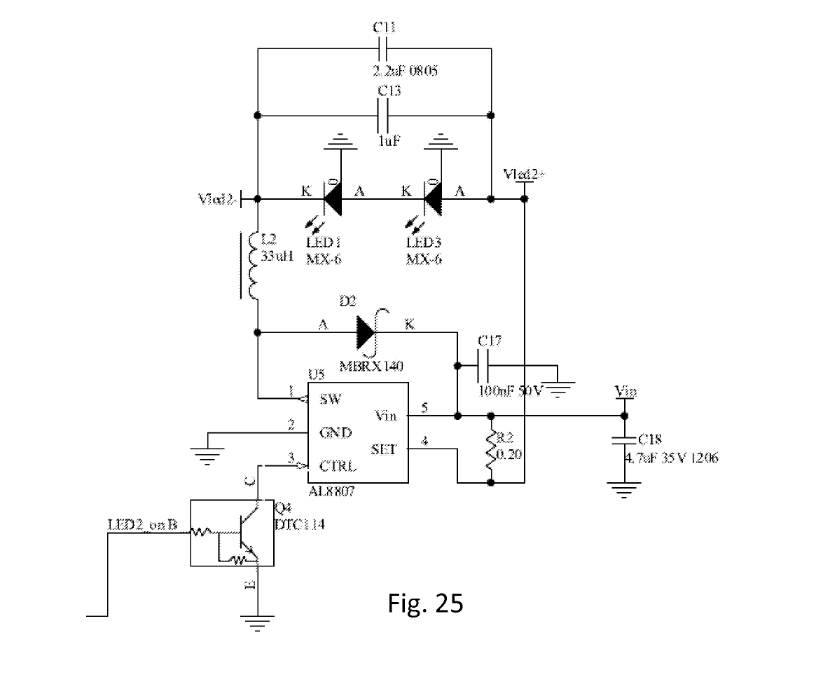

FIGS. 21 through 25 show a schematic of a light engine 50 of the present invention featuring LEDs of a similar color, white or pure light for example.

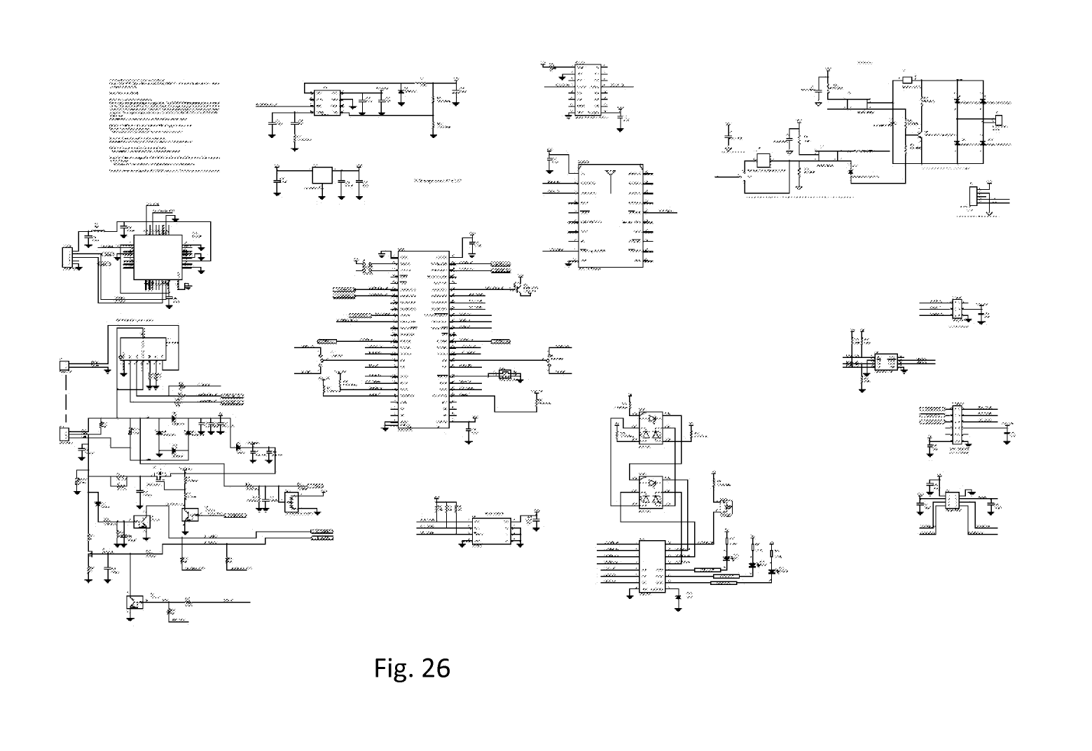

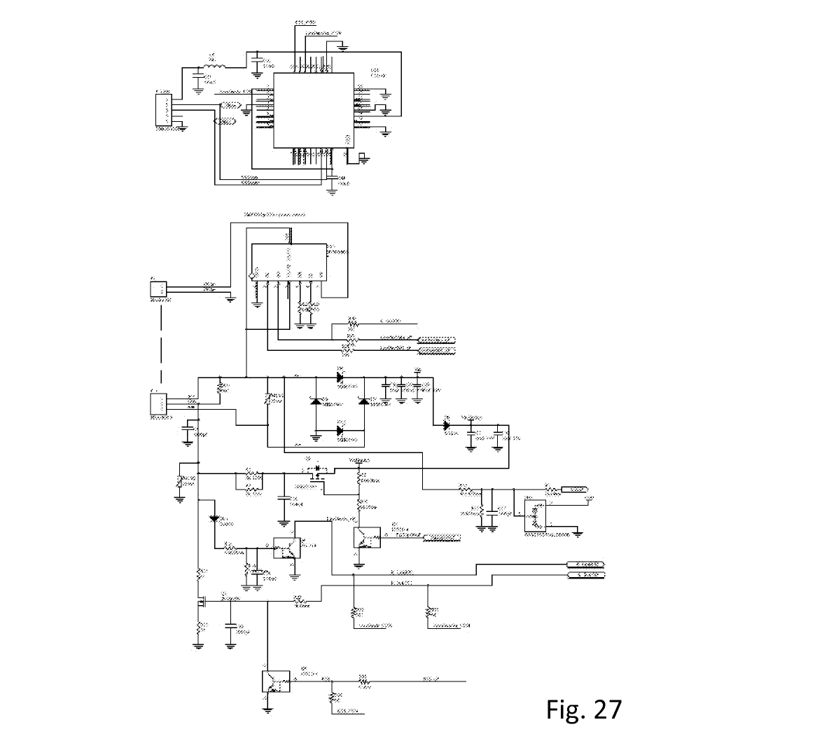

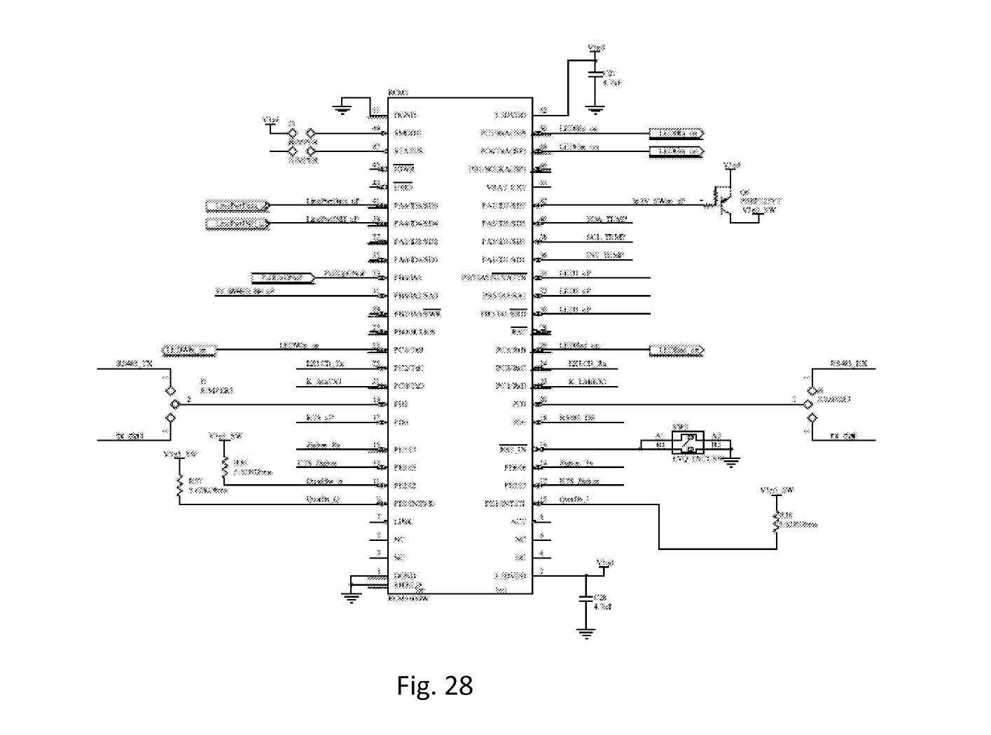

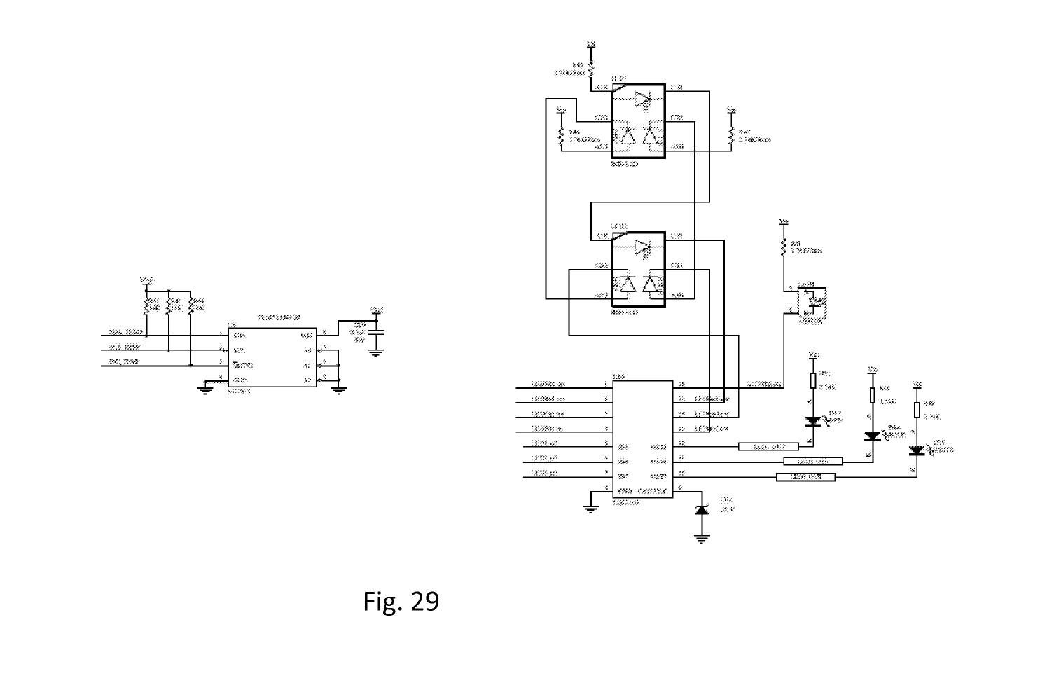

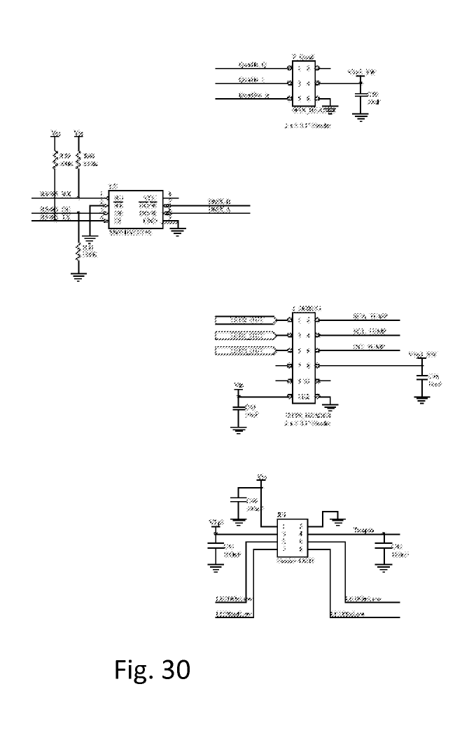

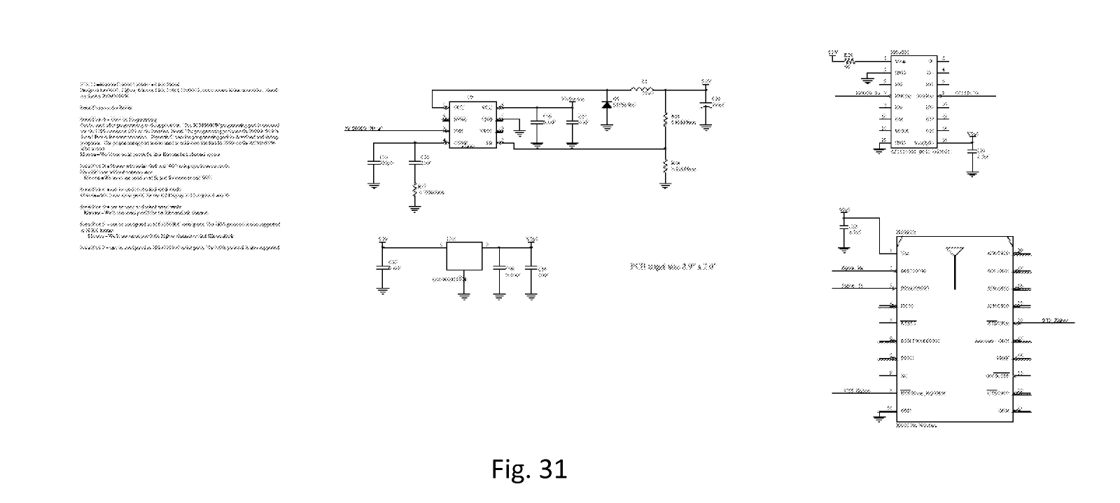

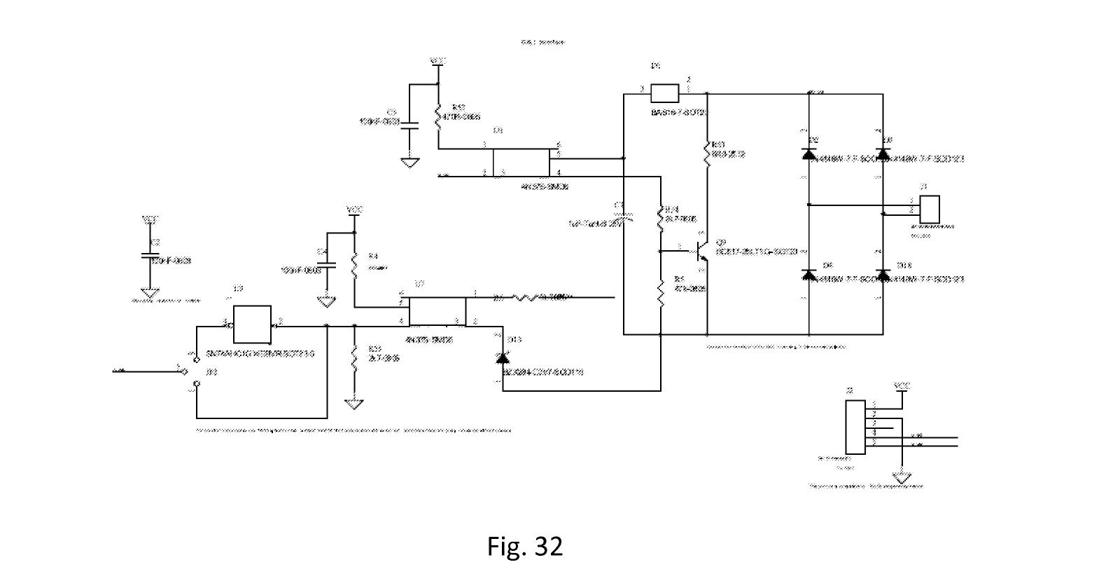

FIGS. 26 through 32 show a schematic for an embodiment of the primary controller 40 of the present invention. This controller includes wired and wireless communication.

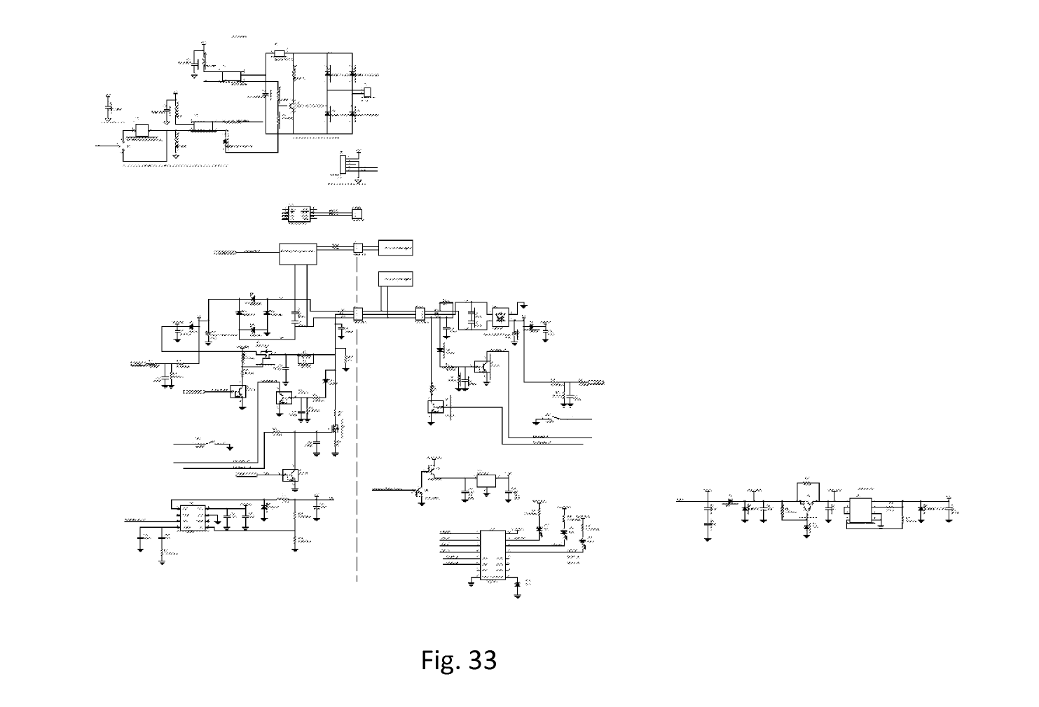

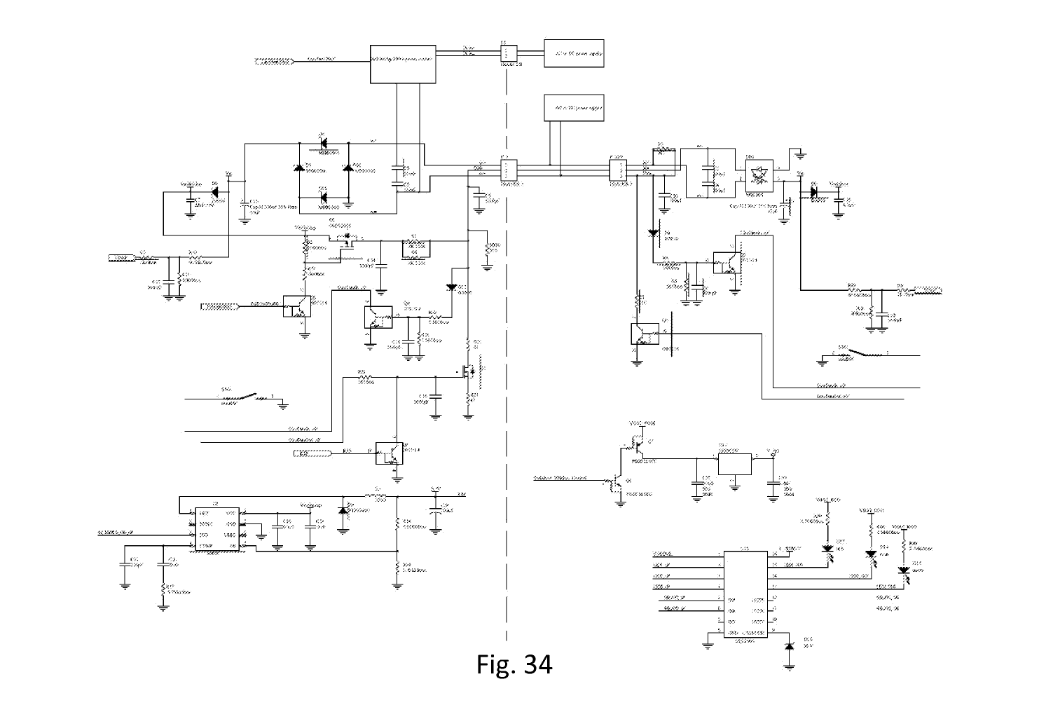

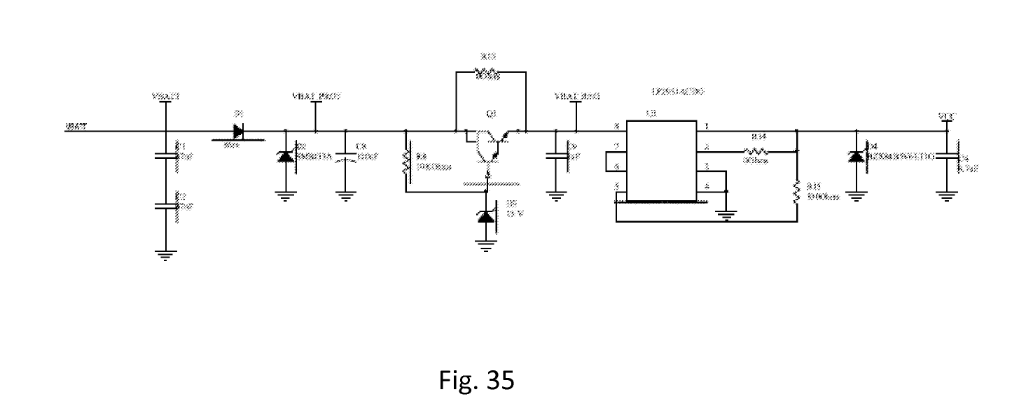

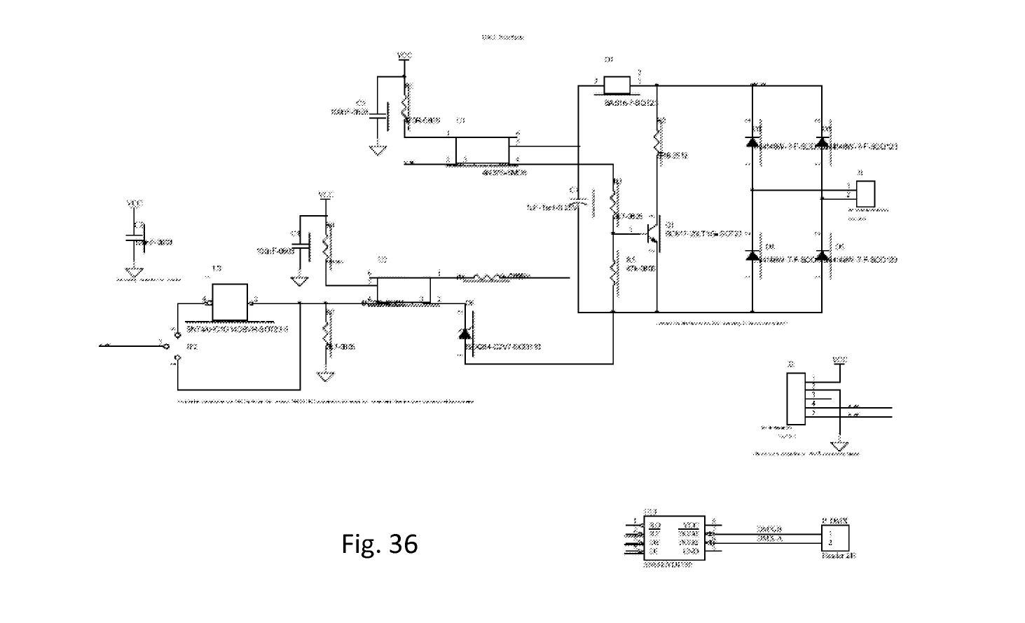

FIGS. 33 through 36 show a schematic of an embodiment of the hardware which can link the primary controller 40 and/or the secondary controller 45 and the light engines 50. This hardware enables the communication and operability between the components discussed supra.

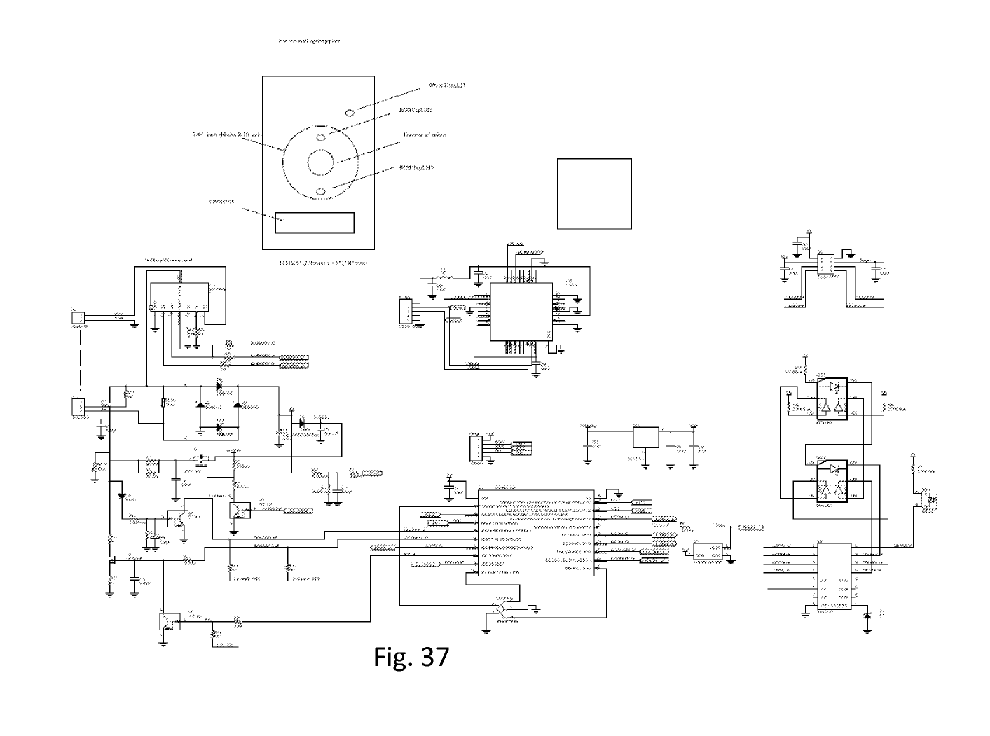

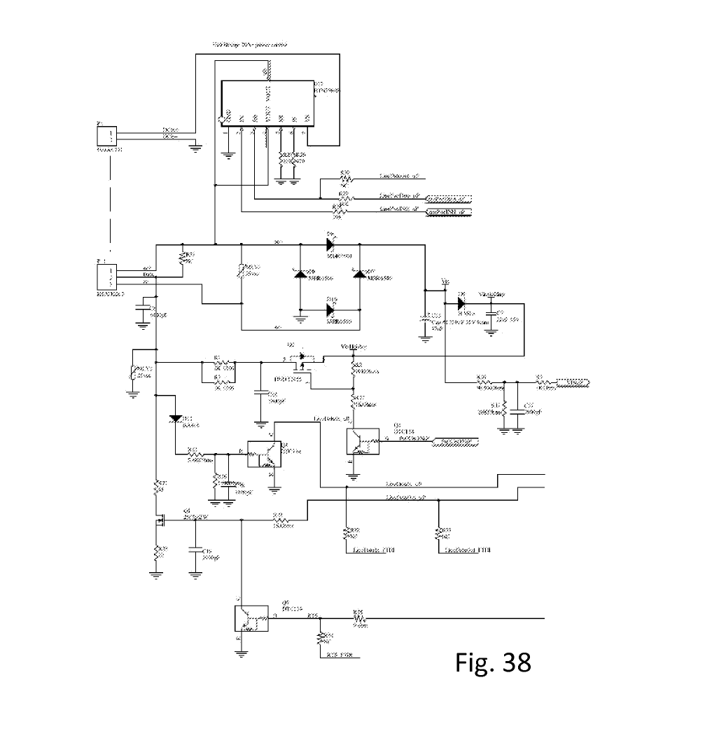

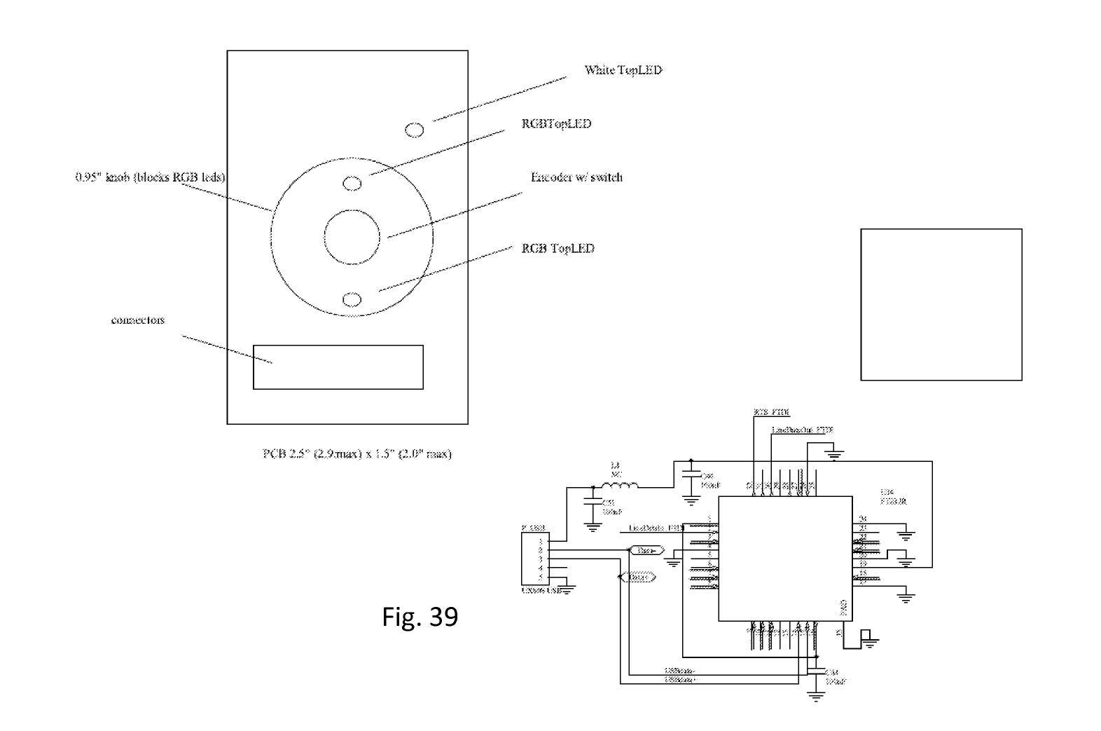

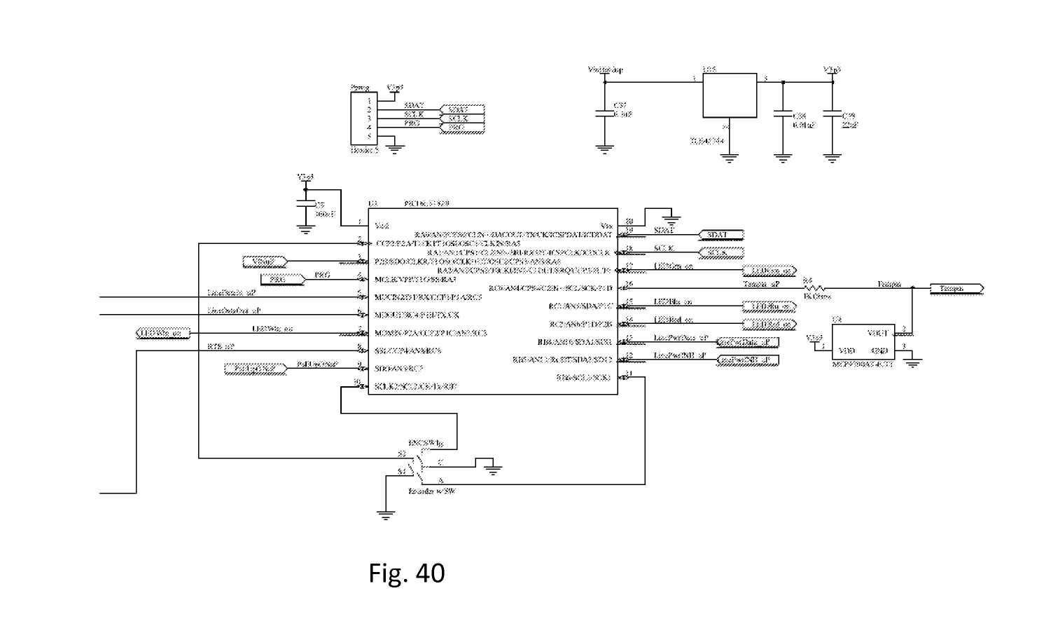

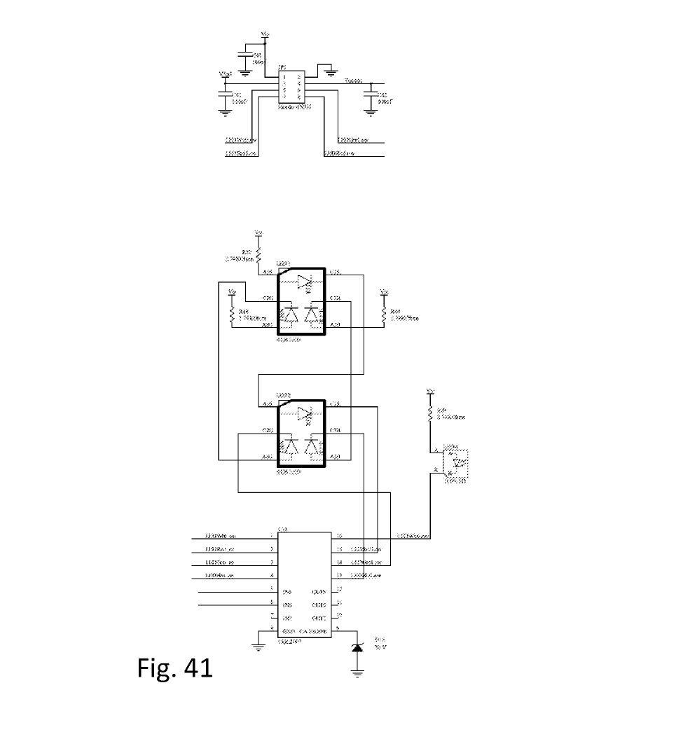

FIGS. 37 through 41 show a schematic of an embodiment of the secondary controller 45.

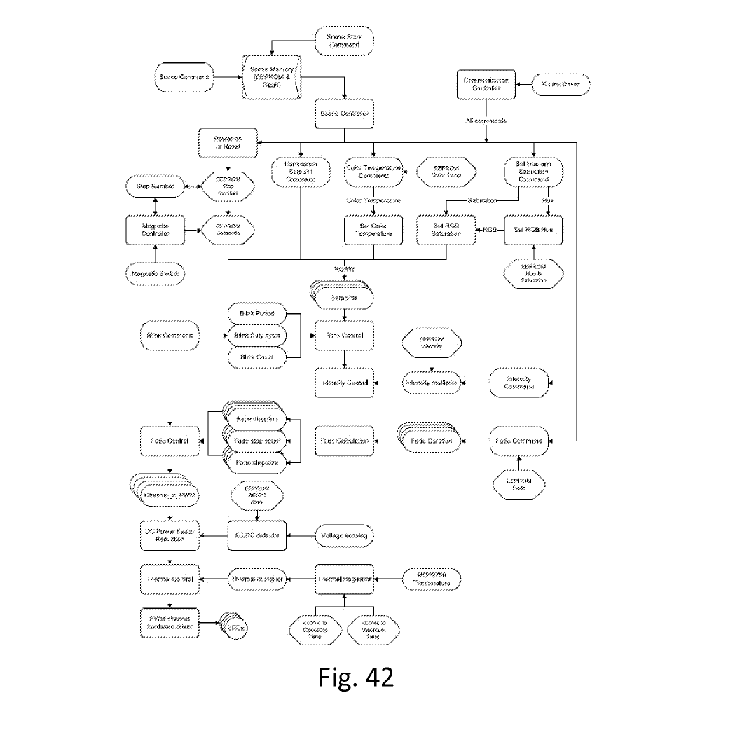

FIG. 42 shows a flow chart for the light engine illumination data transformation. In includes some of the possible commands that can be transmitted in the light engine control system 35.

From the foregoing, it can be seen that the present invention provides a simple yet effective lighting system in which a bidirectional bus provides not only control of the characteristics of the lights from a controller, but also enables the controller to receive information from the lights relating to the status of the lights. That status can include not only the on/off state of the lights in the system, but also the intensity as well as temperature of the various lights.

Having described our invention, many modifications thereto will become apparent to those skilled in the art to which it pertains without deviation from the spirit of the invention as defined by the scope of the appended claims.

We claim:

1. A lighting network connected to a power source, the lighting network comprising:
a controller capable of generating a command and connected to the power source;
a lighting network bus connected to the controller;
a plurality of lighting units capable of generating a response connected to the lighting network bus and the power source, the lighting units having at least one light emitting diode and a plurality of operating states;
the controller operable to generate the commands;
the commands operable to change the state of the lighting units; and
the lighting network bus operable to transmit the command from the controller to the lighting units and the response from the lighting units to the controller.

2. The lighting network of claim 1, further comprising:
the lighting units having a flashing state, the flashing state operable to cause the light emitting diodes of the lighting units to flash; and
the commands operable to change the operating state of the lighting units to the flashing state.

3. The lighting network of claim 1, further comprising:
each of the plurality of lighting units having an individual address on the lighting network; and
the commands operable to change the address of each of the plurality of lighting units.

4. The lighting network of claim 3, further comprising:
a grouping of the addresses, the grouping defined by the controller; and
the controller operable to direct the commands to a specific grouping of lighting units.

5. The lighting network of claim 3, further comprising:
an added lighting unit;
a removed lighting unit;
the controller operable to detect the added lighting unit or the removed lighting unit throughout the lighting network;
the commands operable to change the address of the added lighting unit; and
the commands operable to reassign the address of the removed lighting unit.

6. The lighting network of claim 1, further comprising:
an external magnetic controller that produces a magnetic field;
a magnetic receptor in the plurality of lighting units; and
the magnetic field operable to engage the magnetic receptor and change the operating state of the lighting unit.

7. The lighting network of claim 1, further comprising:
a heating element in the plurality of lighting units, the heating element having a powered heating state and an unpowered nonheating state;
a plurality of thermal sensors in the plurality of lighting units, the thermal sensors operable to measure a lighting unit temperature;
a predetermined low threshold temperature;
the controller or the lighting unit operable to place the heating element in the powered heating state if the lighting unit temperature is less than or equal to the predetermined low threshold temperature; and
the controller or the lighting unit operable to place the heating element in the unpowered nonheating state if the lighting unit temperature is greater than the predetermined low threshold temperature.

8. The lighting network of claim 1, further comprising:
a plurality of thermal sensors in the plurality of lighting units, the thermal sensors operable to measure a lighting unit temperature;
a predetermined high threshold temperature;
a normal powered operating state of the lighting unit;
a low powered operating state of the lighting unit;
the controller or the lighting unit operable to place the lighting unit in the normal powered operating state if the lighting unit temperature is less than or equal to the predetermined high threshold temperature; and
the controller or the lighting unit operable to place the lighting unit in the low powered operating state if the lighting unit temperature is greater than the predetermined high threshold temperature.

9. A method for controlling a lighting network, the method comprising the steps of:
a controller scanning the lighting network for a plurality of lighting units;
the controller identifying each lighting unit as an addressed lighting unit or as an unaddressed lighting unit;
the controller assigning a network address to each unaddressed lighting unit;
the lighting units responding to the controller to confirm assignment of the network address;
the controller receiving an input from a user controlled device;
the controller sending a command to the lighting units; and
the lighting units adjusting a lighting characteristic in response to the command.
